(19) United States
(12) Patent Application Publication
(10) Pub. No.: US 2019/0188338 A1
(43) Pub. Date: Jun. 20, 2019

(54) SYSTEMS AND METHODS FOR WORKSPACE ENVIRONMENT DESIGN AND BUILD

(71) Applicant: Saltmine Pte Ltd., Singapore (SG)

(72) Inventors: Anurag Srivastava, Singapore (SG); Shagufta Anurag, Singapore (SG); Zachi Ekhous, Singapore (SG)

(73) Assignee: Saltmine Pte Ltd., Singapore (SG)

(21) Appl. No.: 16/224,738

(22) Filed: Dec. 18, 2018

Related U.S. Application Data
(60) Provisional application No. 62/607,859, filed on Dec. 19, 2017.

(51) Int. Cl. G06F 17/50; G06T 19/20; G06N 5/00

(52) U.S. Cl. CPC G06F 17/5004; G06N 5/00; G06T 19/20

(57) ABSTRACT

A method of spatially designing a workplace environment via a cloud platform, the method including: receiving user input providing a plurality of design requirements for a workplace environment design; identifying one or more functional blocks from a plurality of predefined functional blocks based at least on the plurality of design requirements, the predefined functional blocks graphically representing a plurality of work space designs, and the functional blocks graphically representing work spaces to be included in the workplace environment design; generating a customized functional list for the workplace environment design, the customized functional list including a list of each of the functional blocks and one or more attributes associated with each of the functional blocks; and generating a spatial plan view of the workplace environment design, the spatial plan view including a visual representation of each of the work spaces of the functional blocks spatially arranged within the workplace environment design.

### CROSS-REFERENCE TO RELATED PATENT APPLICATIONS

This application claims priority to, and the benefit of, U.S. Provisional Application No. 62/607,859, filed on Dec. 19, 2017, which is incorporated herein by reference in its entirety.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### FIELD

One or more aspects of example embodiments of the present disclosure generally relate to systems and methods for designing and building a workspace environment.

### BACKGROUND

Some corporations, businesses, and entities consider the physical workspace as a communication tool rather than simply as real estate. They understand that employees who enjoy and like the environments that they are a part of are generally more engaged, productive, happy, and healthy. Further, research has shown that there is a strong correlation between the physical workspace and business performance metrics, productivity, and employee values.

However, workspace design and build is generally a linear process where one phase follows another phase, such as requirement gathering, design, visualization, and bill of materials (BOM) generation. The phases have high interdependence and correlation with each other so that multiple revisions and changes are usually needed, which generally results in an expensive, frustrating, and time consuming journey without having a clear and predictable outcome.

### SUMMARY

The present solution brings all phases of workplace design and build into a single interactive design platform powered by knowledge and rules. The capability now for customers using the platform of the present solution is to be able to do strategic design thinking within the workspace impacting innovation, productivity, employee satisfaction, talent recruitment and brand impact which has been recognized as a huge value to business now by both business leaders and employees.

The systems and methods described herein provide an end to end solution for the corporates to rely on during the design of a new office or work space (e.g., workplace environment design) that effectively integrates multiple stakeholder engagement, multiple stages of design, products—materials selection, costing, brand experience, knowledge, innovation, 3 dimensional and VR (virtual reality) graphical designs—all in a single easy to use cloud platform. The 2D, 3D generation of the graphical spatial plan views and costing are all integrated, allowing the teams to work in either views, as it's all just one truly connected model, which automatically reflects changes in all other invisible views. The powerful tool gives product and material options and its impact on cost to help make quick informed decisions.

The platform of the present solutions transforms spaces where they are organic and built by users rather than only by design professionals. For an occupier to a driver of the workplace design process; the platform's tools are simple, efficient, interactive and collaborative. The ability to generate high quality 3D representations that can be explored interactively on any device, and manipulated by different stakeholders—anywhere in the world, makes value out of business stakeholders allocating time for project inputs. The design process from the linear, now becomes agile, collaborative and powered by design guidelines and branding products.

The business and design teams can now collaborate at the project initiation stage. The project timeline is reduced by weeks, and the productivity improved significantly. The results are more predictable and the journey is collaborative and enjoyable. The end user and business has better visibility to their office space and can make decisions in a 3-dimensional spatial context and experience walkthrough in virtual reality, after making the changes to the design of the space along with the design team. This helps reduce multiple revisions and saves time and improves the incorporation of user inputs into design.

With the platform of the present solution, designers and business teams are able to plan a workplace based on work style, work process and utilization data along with the ability to visualize the space in 3D, make changes that reflect in real time as well as showcase the impact on budget, and timeline. Catalogs of materials, and finishes are available instantly and the interface allows direct collaboration with all of the stakeholders involved.

Aspects of the platform include but are not limited to the following:

Online design platform supporting 2D, 3D and VR visualization;

Rich catalogs of: pre-defined blocks, products and furniture, materials and finishes, and branding material, managed centrally via back-office tools;

Product catalog is filtered based on available budget;

Simple and intuitive drawing tools for floor plan architecture, including:

external and internal walls, openings—doors and windows;

Block based design—drag-and-drop predefined blocks, including all elements—walls, doors, furniture, finishes and integrated technology (IT, Audio/Visual, etc.);

WYSIWYG (What You See is What You Get)—interactive replacement of blocks, furniture and finishes is automatically reflected in all views across 2D, 3D and Virtual Reality; and

Automatic analysis of the design and generation of project's BOM (Bill of Materials).

According to an example embodiment, a method of spatially designing a workplace environment via a cloud platform, includes: receiving, by a user interface of a workspace design cloud platform executing one or more processors, user input providing a plurality of design requirements for a workplace environment design including a graphical representation of a workplace environment; identifying, by one or more rules of the workspace design cloud platform in communication with a knowledge base, one or more functional blocks from among a plurality of predefined functional blocks based at least on the plurality of design requirements, the predefined functional blocks graphically representing a plurality of work space designs, and each of the one or more functional blocks graphically representing one or more work spaces to be included in the workplace environment design; generating, by the workplace design cloud platform, a customized functional list for the workplace environment design, the customized functional list including a list of each of the functional blocks and one or more attributes associated with each of the functional blocks; and generating, by the workplace design cloud platform, one or more spatial plan views of the workplace environment design based at least on the customized functional list, each of the one or more spatial plan views including a visual representation of each of the one or more work spaces of the functional blocks spatially arranged within the workplace environment design.

In some embodiments, each of the predefined functional blocks may include one or more parameters that define a space for a corresponding work space design.

In some embodiments, the one or more parameters may include a category parameter that characterizes a spatial type of the space.

In some embodiments, the one or more parameters may further include a type parameter that defines a function or size of the space.

In some embodiments, the one or more parameters may further include a PAX parameter that defines a number of persons or seats that can occupy the space.

In some embodiments, the identifying of the one or more functional blocks may include: identifying, by the workspace design cloud platform, a first data point of the user input, the first data point indicating types of spaces, spatial layout, and spatial placement for the one or more work spaces associated with the workplace environment design; and filtering, by the workspace design cloud platform, the predefined functional blocks based on the first data point to isolate the predefined blocks that have the work space designs corresponding to the one or more work spaces associated with the workplace environment design.

In some embodiments, the first data point may be a work culture data point corresponding to an aspired work culture defining a spatial plan for the workplace environment design.

In some embodiments, the identifying of the one or more functional blocks may further include: assigning, by the workspace design cloud platform, block attributes for each of the one or more workspaces associated with the workplace environment design; and selecting, by the workspace design cloud platform, one or more of the filtered predefined blocks having the one or more parameters that correspond to the block attributes assigned for the one or more workspaces associated with the workplace environment design.

In some embodiments, the method may further include: assigning, by the workspace design cloud platform, an area fit for each of the selected predefined blocks; and optimizing, by the workspace design cloud platform, each of the selected predefined blocks based at least on the area fit and available space.

In some embodiments, the optimizing of the selected predefined blocks may include: determining, by the workspace design cloud platform, an upgrade priority based at least on the first data point for each of the one or more workspaces associated with the workplace environment design; and upgrading, by the workspace design cloud platform, one or more of the functional blocks based on the upgrade priority to reduce residual space.

According to another embodiment, a workplace design cloud platform for spatially designing a workplace environment, includes: one or more processors; and non-transient computer-readable storage media communicably coupled to the one or more processors and having instructions stored thereon that, when executed by the one or more processors, cause the one or more processors to: receive, via a user interface generated by the one or more processors, user input providing a plurality of design requirements for a workplace environment design including a graphical representation of a workplace environment; identify, based on one or more rules in communication with a knowledge base, one or more functional blocks from among a plurality of predefined functional blocks based at least on the plurality of design requirements, the predefined functional blocks graphically representing a plurality of work space designs, and each of the one or more functional blocks graphically representing one or more work spaces to be included in the workplace environment design; generate a customized functional list for the workplace environment design, the customized functional list including a list of each of the functional blocks and one or more attributes associated with each of the functional blocks; and generate one or more spatial plan views of the workplace environment design based at least on the customized functional list, each of the one or more spatial plan views including a visual representation of each of the one or more work spaces of the functional blocks spatially arranged within the workplace environment design.

In some embodiments, each of the predefined functional blocks may include one or more parameters that define a space for a corresponding work space design.

In some embodiments, the one or more parameters may include a category parameter that characterizes a spatial type of the space.

In some embodiments, the one or more parameters may further include a type parameter that defines a function or size of the space.

In some embodiments, the one or more parameters may further include a PAX parameter that defines a number of persons or seats that can occupy the space.

In some embodiments, to identify the one or more functional blocks, the instructions may further cause the one or more processors to: identify a first data point of the user input, the first data point indicating types of spaces, spatial layout, and spatial placement for the one or more work spaces associated with the workplace environment design; and filter the predefined functional blocks based on the first data point to isolate the predefined blocks that have the work space designs corresponding to the one or more work spaces associated with the workplace environment design.

In some embodiments, the first data point may be a work culture data point corresponding to an aspired work culture defining a spatial plan for the workplace environment design.

In some embodiments, to identify the one or more functional blocks, the instructions may further cause the one or more processors to: assign block attributes for each of the one or more workspaces associated with the workplace environment design; and select one or more of the filtered predefined blocks having the one or more parameters that correspond to the block attributes assigned for the one or more workspaces associated with the workplace environment design.

In some embodiments, the instructions may further cause the one or more processors to: assign an area fit for each of the selected predefined blocks; and optimize each of the selected predefined blocks based at least on the area fit and available space.

In some embodiments, to optimize the selected predefined blocks, the instructions may further cause the one or more processors to: determine an upgrade priority based at least on the first data point for each of the one or more workspaces associated with the workplace environment design; and upgrade one or more of the functional blocks based on the upgrade priority to reduce residual space.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIG. 2 is a block diagram of a workplace design cloud platform, according to some embodiments;

FIGS. 3A-3I are example prompts to a questionnaire for gathering user requirements, according to some embodiments;

FIGS. 4A and 4B show an example project plan or customer functional list, according to some embodiments;

FIGS. 5A-5C illustrate various spatial plan views of a workspace environment design, according to some embodiments;

FIGS. 5D and 5E illustrate a bill of materials for a workspace environment design, according to some embodiments;

FIG. 6 is a flow diagram of a method for propagating changes or modifications throughout the various stages of a workspace environment design, according to some embodiments;

FIG. 7 is a flow diagram of a method for generating a project plan or customer functional list based on user requirements, according to some embodiments; and

FIG. 8 is a flow diagram of a method for automatically filtering a product catalog based on user requirements and budget, according to some embodiments.

### DETAILED DESCRIPTION

In some embodiments, a workspace design cloud platform is provided in which the workspace environment may be designed by users rather than only by design professionals. The workspace design cloud platform may allow businesses and design teams to collaborate from the project initiation phase all the way through BOM, where changes at any stage automatically propagates throughout the entire design. Thus, what was generally a manually intensive linear process requiring multiple revisions, change requests, and approvals for any changes at any stage, is now automatically applied to each stage so that the effects of the changes on the entire design at any stage can be graphically visualized in any of views or user interfaces in real-time (or near real-time). For example, in some embodiments, a change to any of the elements of the workplace environment design at the BOM stage is automatically reflected in the various spatial plan views. Likewise, a change to any of the elements in one of the spatial plan views is automatically reflected in the other views as well as in the BOM. Accordingly, the results are more predictable, and the journey may be more collaborative and enjoyable. Further, project timelines may be reduced, while improving productivity.

In some embodiments, the workspace design cloud platform may automatically generate multiple spatial plan views of the design, which allows businesses and users to have better visibility to their design and to make better change decisions. The multiple spatial plan views are graphically displayed to the users, and the users can interact with any of the graphical views to make changes to any of the elements of the design, which is then automatically applied to each of the other graphical spatial plan views. Accordingly, incorporation of user inputs into the design may be improved, while reducing multiple revisions of the design.

In some embodiments, the workspace design cloud platform may automatically generate a BOM to centralize expenses and budgeting of the workspace design. In some embodiments, catalogues of products, materials, and finishes are available and automatically incorporated into the BOM. Accordingly, the budget for the entire design may be easily managed.

The various embodiments of the present disclosure described herein improve computer-related technology by performing certain steps that cannot be done by conventional workplace design systems or human actors. For example, the workspace design cloud platform is configured to electronically collect user-defined requirements for a particular workplace environment design to automatically generate data corresponding to each stage of the workplace environment design, and to graphically display each of the generated stages to a user. In some embodiments, to achieve benefits over conventional drafting tools and systems that require a professional drafter to manually generate each of the spatial plan views based on requirements of the workplace environment design, the workspace design cloud platform utilizes predefined functional blocks that graphically represent each of the work spaces in a particular workplace environment design to automatically generate each of the spatial plan views graphically. For example, in some embodiments, the workspace design cloud platform automatically selects relevant functional blocks for a workplace environment design from among the predefined functional blocks based on a customized knowledge base and rules for spatial placement, adjacency priorities, and constraints. The workspace design cloud platform customizes each of the functional blocks and automatically arranges the functional blocks graphically in various spatial plan views for the workplace environment design based on a particular combination of the user-defined design requirements. Further, to achieve benefits over convention drafting tools and systems, in some embodiments, the workspace design cloud platform provides a user interface to allow users to drag and drop function blocks and/or elements within the functional blocks to rearrange or modify the spatial plan views.

For purposes of reading the description of the various embodiments below, the following descriptions of the sections of the specification and their respective contents may be helpful:

Section A describes a network environment and computing environment which may be useful for practicing embodiments described herein.

Section B describes embodiments of a workplace design cloud platform and methods for designing and building a workspace environment using the same.

A. Computing and Network Environment

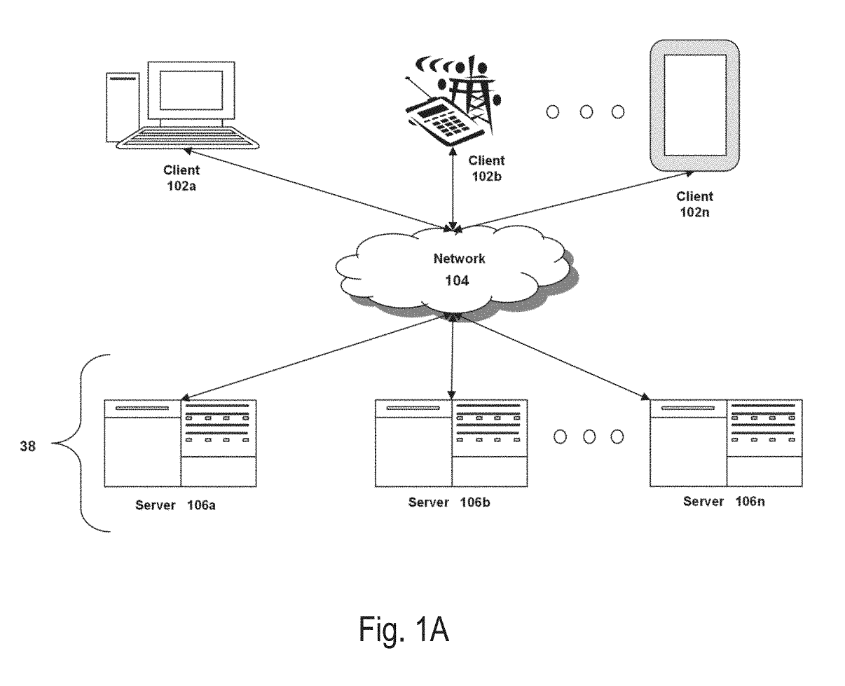

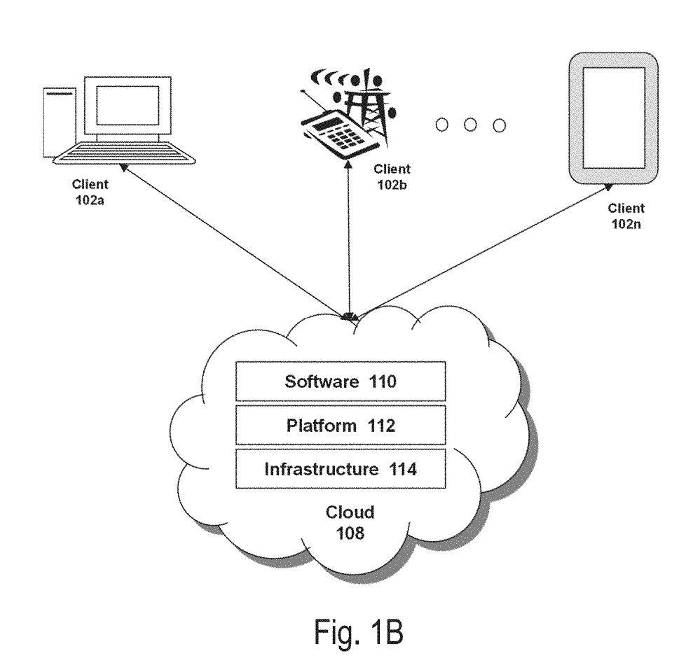

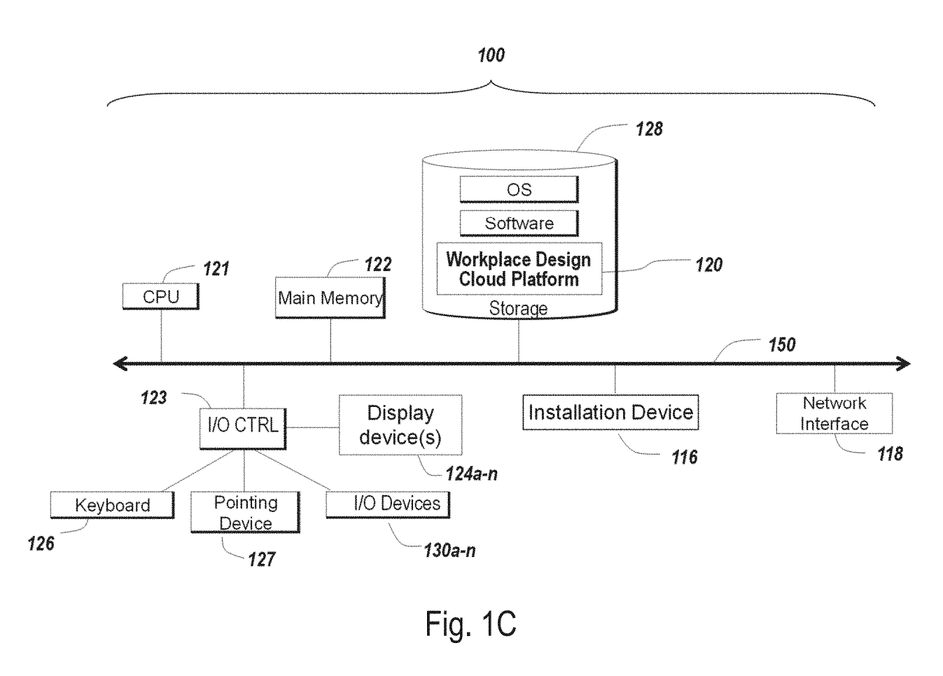

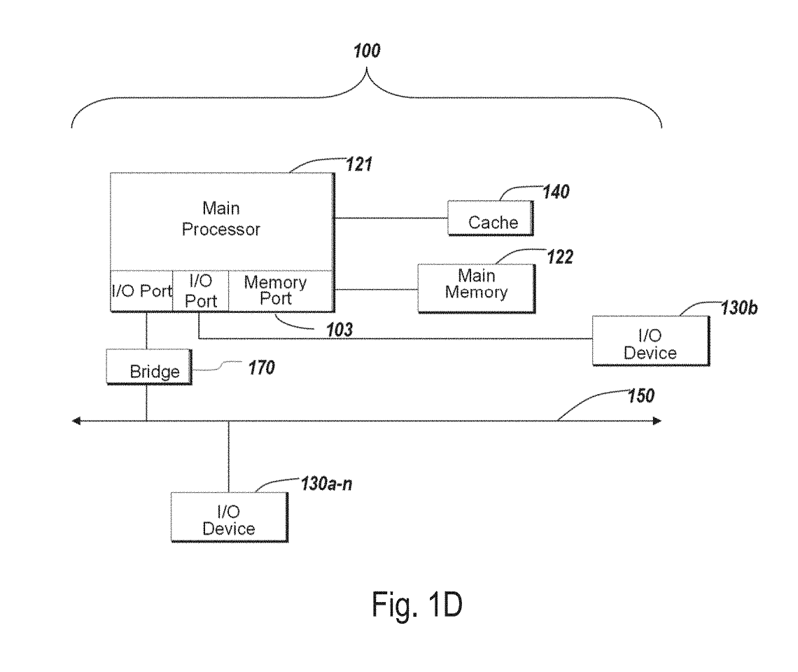

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a workplace design cloud platform 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AND PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the workplace design platform. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Workplace Design Cloud Platform

Systems and methods of the present solution are directed to a workplace design cloud-based platform which may enhance collaboration between various stakeholders for designing and/or building a workplace environment. In some embodiments, the workplace design cloud platform may integrate a user's content, rules, knowledge, analytics, brand, culture, and style into the workplace environment design. In some embodiments, the workplace design cloud platform may generate a customized project plan or functional list based on the user's needs and requirements. In some embodiments, the project plan or functional list may include a plurality of predefined functional blocks that graphically represent various work spaces in the workspace environment design.

In some embodiments, the workplace design cloud platform may automatically generate 2-dimensional (2-D), 3-dimensional (3-D), and/or virtual reality (VR) spatial plan views that graphically represent the workplace environment design based on the functional blocks. In some embodiments, the workplace design cloud platform may include a design tool to add, modify, customize, or delete individual elements and component within the functional blocks as needed or desired, and the additions, modifications, customization, and deletions may be automatically reflected in all spatial plan views.

In some embodiments, the workplace design cloud platform may help to manage all of the project costs and requirements including, for example, budget, engineering requirements, resource requirements, and bill of materials (BOM). In some embodiments, the workplace design cloud platform may provide a marketplace for various 3^{rd} party products and services that can be incorporated into the workplace environment design, and managed in terms of overall cost, requirements, and BOM.

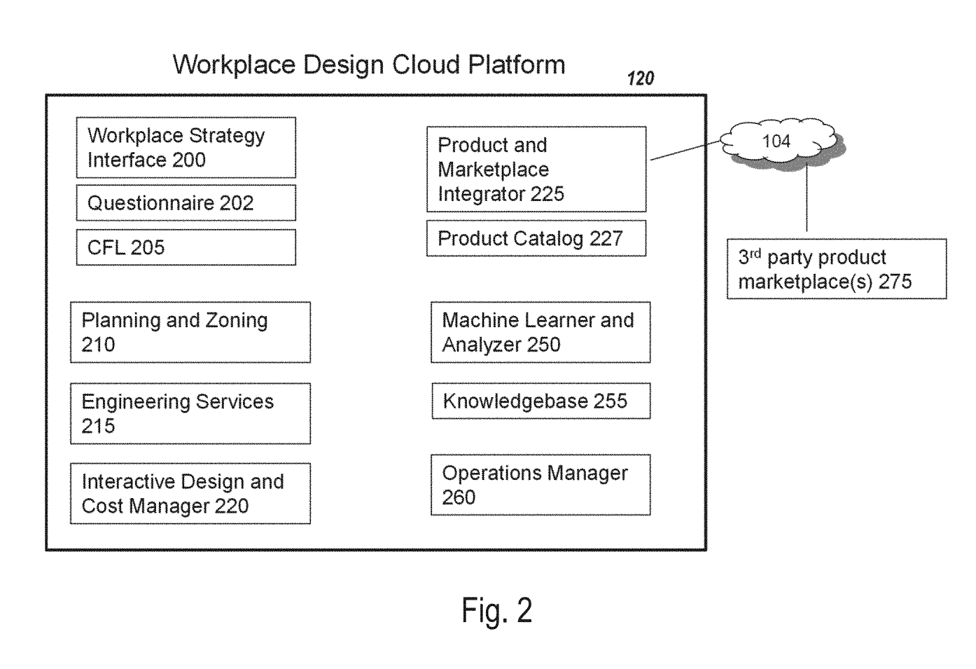

FIG. 2 is a block diagram of a workplace design cloud platform according to some embodiments. In some embodiments, the workplace design cloud platform 120 may be implemented using a distributed or cloud computing environment with a plurality of processors and memory. That is, the various services, modules, and components of the workplace design cloud platform 120 as shown in FIG. 2 can be distributed across multiple servers or computers (e.g., that can exist in distributed locations). However, the present disclosure is not limited thereto, and in some embodiments, workplace design cloud platform 120 can be implemented within a single computer (e.g., one server, one housing, etc.).

In some embodiments, the workplace design cloud platform 120 includes a workplace strategy interface 200, planning and zoning 210, engineering services 215, interactive design and cost manager 220, product and marketplace integrator 225, and operations manager 260. In some embodiments, workplace design cloud platform 120 may be connected to one or more 3^{rd} party product marketplaces 275 via network 104 to receive (or generate) a 3^{rd} party product catalogue. Each of these services, modules, and components of the workplace design cloud platform 120 will be described in further detail below.

The services, modules, and components of the workplace design cloud platform 120 may comprise any type and form of application, program, library, service, process, task or any type and form of executable instructions executable on a computing device. In some embodiments, any of the services, modules, and components of the workplace design cloud platform 120 may be driven by and/or implemented with a knowledge base and/or machine learning. The knowledge base may comprise any information, data, logic, rules and/or policies to implement, direct, select, improve or optimize any of the data, design and output of any of the services, modules, and components of the workplace design cloud platform 120. The knowledge base may include any of the input, output, data and information of any workplace strategies, requirements, designs, design changes, or any other design decisions and selections in using the platform for multiple different users, companies, designers, etc. A machine learner or machine learning tool and algorithm 250 may use any of the data in the knowledge base and/or from prior uses of the platform to perform machine learning, classify data and make models for use by the platform.

### Workplace Strategy Interface

Still referring to FIG. 2, the workplace strategy interface 200 may provide a user interface (e.g., UX/UI), such as web-based interface, to gather user inputs and requirements, and may automatically analyze the user inputs and requirements to generate a customized project plan or functional list for the workspace environment design. For example, in some embodiments, the workplace strategy interface 200 may provide an electronic questionnaire 202 or a set of prompts to the user via a user interface to gather the user's requirements and needs, and may generate a customized customer functional list (CFL) 205 based on the user's responses or inputs to the questionnaire 202. In some embodiments, the workplace strategy interface 200 may include an application programming interface (API) to receive inputs to the platform via another system, application, program or interface. In some embodiments, the workplace strategy interface 200 may include an application programming interface (API) to receive a file or other document to use as input to the system, such as previously filled out questionnaire.

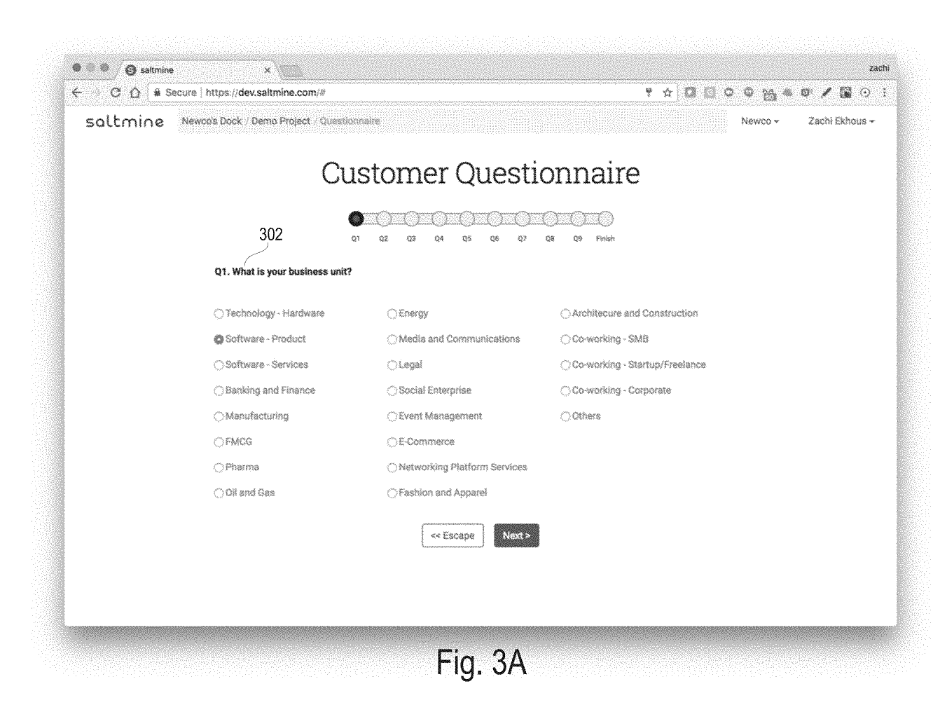

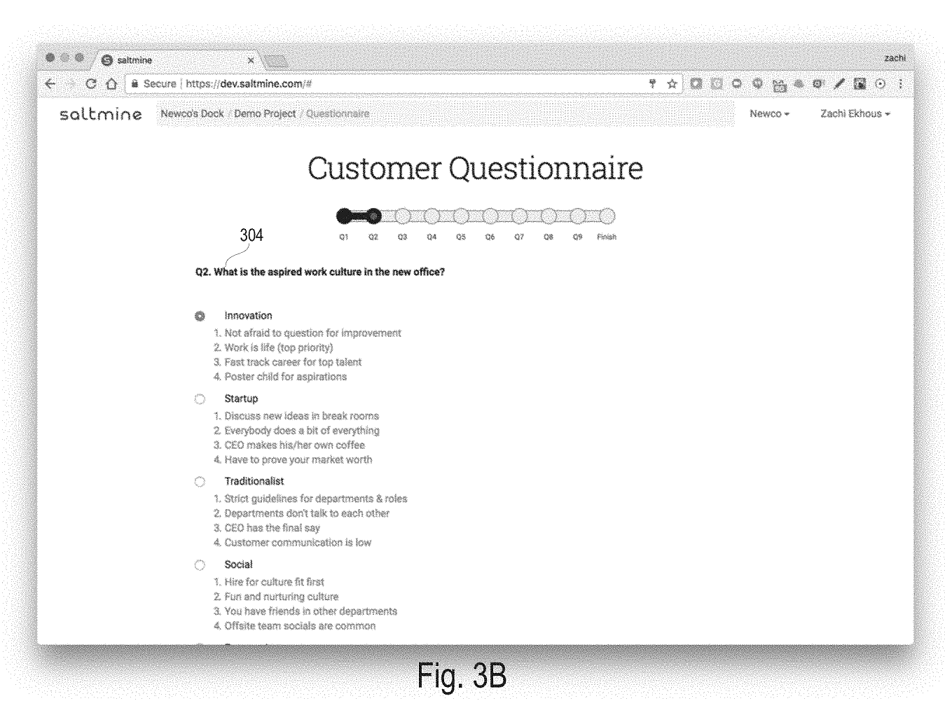

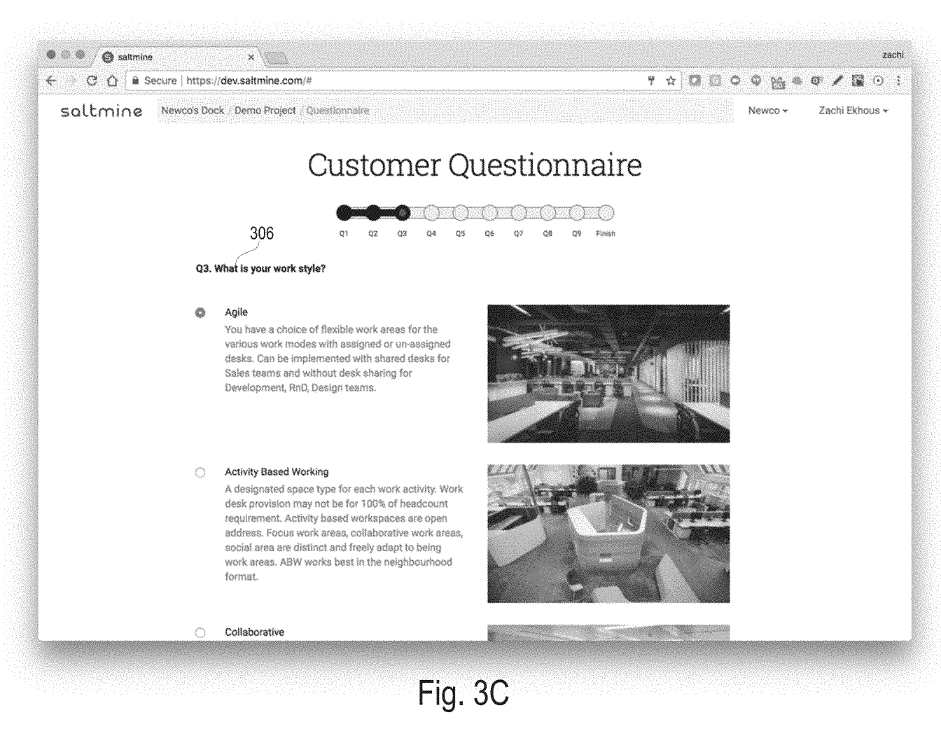

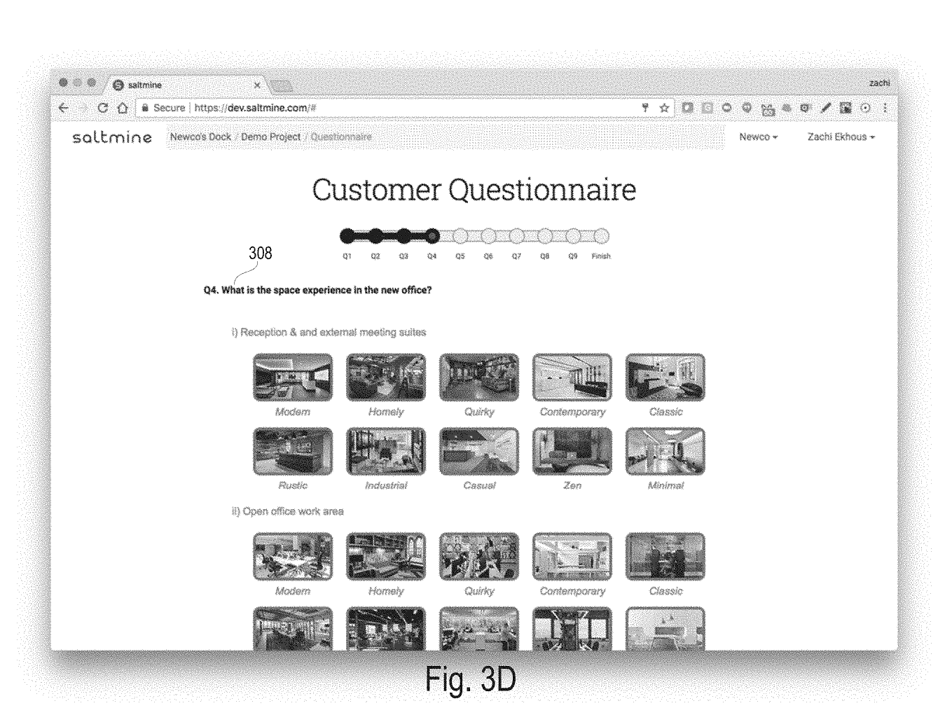

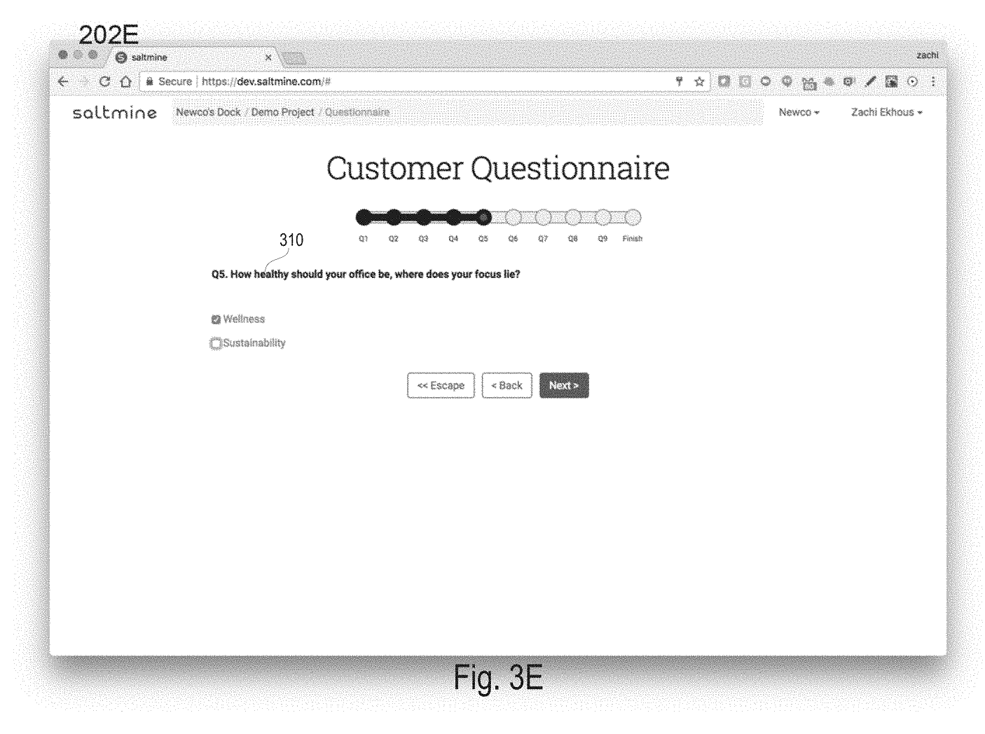

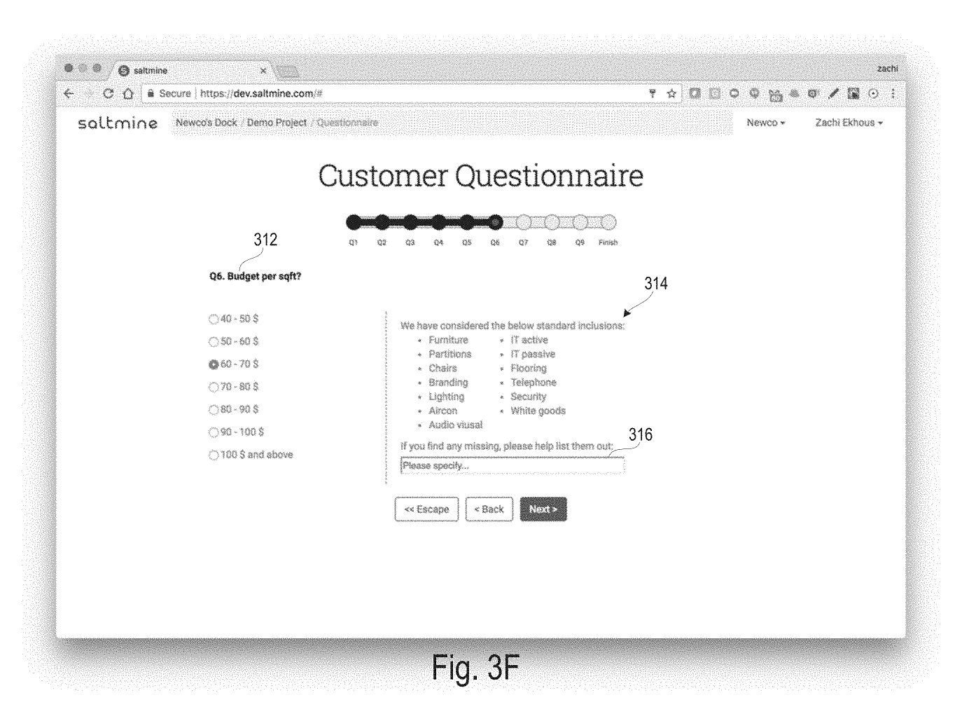

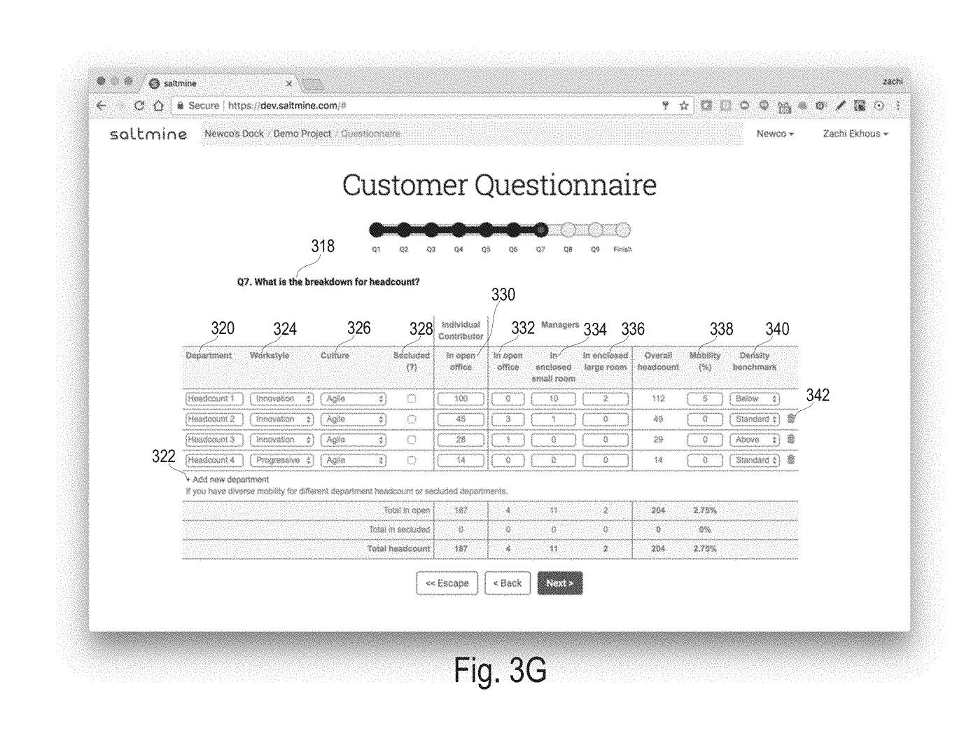

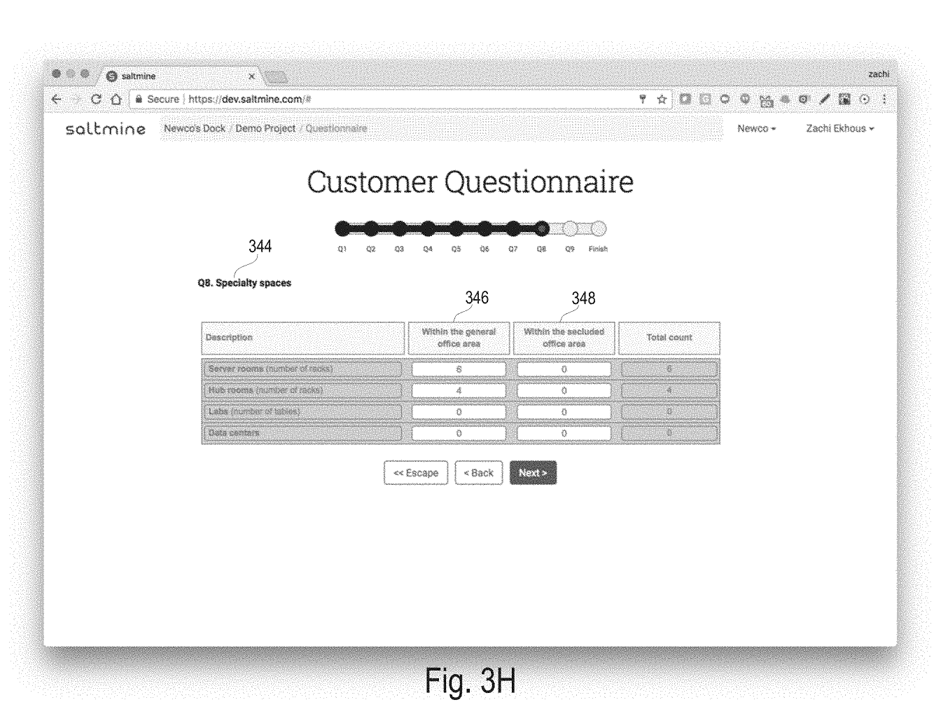

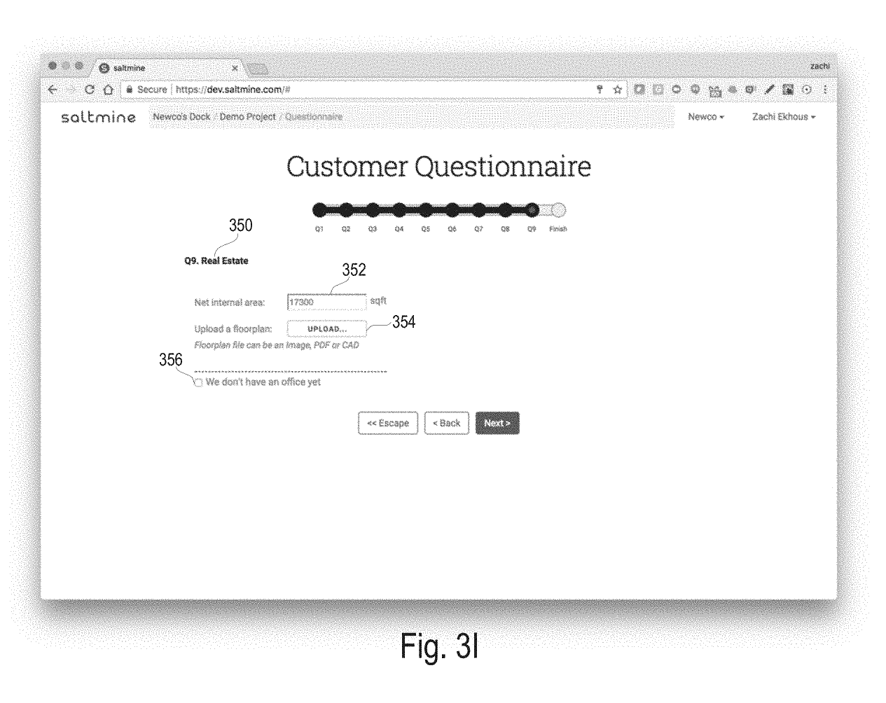

In some embodiments, the online or electronic questionnaire is customized to a profile of a user or customer. The profile may identify or specify any attributes of the user or customer's industry/work sector, culture and/or work style. In some embodiments, a particular input or response to a prompt in the questionnaire may affect one or more subsequent prompts in the questionnaire. For example, a response or input to a previous prompt or question in the questionnaire may alter a number, order, and/or content of a subsequent prompt(s) in the questionnaire 202 (for example, where the prompt is not applicable based on an answer or input to the previous prompt). In some embodiments, the platform via the knowledge base, rules and/or machine learning may determine the list of questions or prompts, or subsequent questions or prompts based on the user or customer profile and/or past user/customer's questions and answers to the same. Accordingly, while some example questions to the questionnaire 202 are shown and described with reference to FIGS. 3A-3I, these are non-limiting examples, and thus, the present disclosure is not limited thereto.

In some embodiments (e.g., as shown in FIGS. 3A-3F), the user may be prompted to choose a response (or input) from a list of available predetermined responses (e.g., via selection of a radial button, link, drop-down menu, and the like). However, the present disclosure is not limited thereto. For example, in other embodiments, the user may type or speak an answer or description in response to a prompt, and the workplace strategy interface 200 may utilize speech and/or text recognition to determine (or suggest) a proper input or response. In some embodiments, the platform may customize, configure or specify the user interface for each customer or user to provide the customized questionnaire, such as customizing the prompt and user interface elements to receive answers to the prompts.

Referring to FIG. 3A, according to some embodiments, the questionnaire 202 may first prompt the user to select or describe a sector 302 for the workspace environment. The sector may identify or specify the type of business, trade or industry the user or customer is in, such as and not limited to any of the following: technology-hardware, software-product, banking and finance, manufacturing, fast moving consumer goods, pharma, energy, media and communications, legal, social enterprise, event management, e-commerce, networking platform services, fashion and apparel, architecture and construction, co-working—small medium business, co-working—startup or freelance, co-working—corporate or other. In some embodiments, the sector data point may help define the type of spaces, materials, appliances, equipment, machinery, and/or security that is likely needed or desired for the workspace environment design. Some non-limiting examples of the types of sectors may include the type of business, industry, trade, and/or the like. However, the present disclosure is not limited to the types or number of sector examples shown in FIG. 3A.

Referring to FIG. 3B, according to some embodiments, the questionnaire 202 may prompt the user to select or describe an aspired work culture 304 for the workspace environment. Some non-limiting examples of the aspired work culture may include innovation, startup, traditionalist, social, progressive, risk-reward, and the like. However, the present disclosure is not limited to the number or types of the aspired work culture examples shown in FIG. 3B.

In some embodiments, an innovation work culture may be defined as one in which individuals are encouraged to constantly seek improvement and efficiencies. Work life is generally top priority, and top talent and performers are awarded with fast track career opportunities. The innovation work culture may be generally described as a culture of promoting aspirations.

In some embodiments, a startup work culture may be defined as one in which each individual contributor or employee does a little bit of everything. Everyone in a startup work culture wears multiple hats, and the line for individual roles are blurred. In the startup work culture, the business as well as the individuals are constantly trying to prove their market worth.

In some embodiments, a traditionalist work culture may be defined as one in which individual roles are well defined, with strict guidelines for departments and roles within the business. The traditionalist work culture is a top-down approach where individuals in different departments generally do not communicate with each other, and the CEO generally has the final say in any big decision.

In some embodiments, a social work culture may be defined as one in which individuals are hired based on culture fit first. The social work culture is generally a fun and nurturing environment where offsite team socials are common. In the social work culture, intra-department as well as inter-department friendships between individuals are common.

In some embodiments, a progressive work culture may be defined as one in which changes occur frequently, for example, through mergers and acquisitions. Turnover rate is high in a progressive work culture, and individuals talk openly about competition and buyouts. In the progressive work culture, revenue closely tracks market changes.

In some embodiments, a risk-reward work culture may be defined as one in which individuals are highly motivated and driven to constantly produce high work performance. In the risk-reward work culture, competition between individuals may be fierce, where individuals take high risks for high rewards. For example, in the risk-reward culture individuals may be compensated mainly based on commission rather than salary (e.g., sales culture). Thus, the risk-reward work culture may be structured to extract the best performance from each individual.

In some embodiments, the work culture data point may define a spatial plan or spatial template for the workspace environment design, that is used as input to suggest, identify recommend or optimize the types of spaces, space layout, spatial placement, and various attributes for each of the spaces in the workplace environment design. For example, a startup work culture may emphasize larger open spaces where every individual can work and collaborate, whereas a traditionalist work culture may emphasize smaller offices and meeting rooms for individuals and departments. Thus, in some embodiments, the work culture data point may be one of the drivers or inputs for defining the customized project plan or functional list for the workspace environment design. In some embodiments, the platform via the knowledge base, rules and/or machine learning may use the work culture data point to determine any of the elements of the project plan or functional list for the workplace design.

Referring to FIG. 3C, according to some embodiments, the questionnaire 202 may prompt the user to select or describe the work style 306 for the workspace environment. Some non-limiting examples of the work style may include agile, activity based working, collaborative, collaboratory, and co-working. However, the present disclosure is not limited to the number or types of the work style examples as shown in FIG. 3C.

In some embodiments, an agile work style may be defined as one in which flexible work areas are provided with assigned and/or unassigned desks. For example, shared desks for sales teams may be provided, whereas assigned desks or work areas for development, design, and research departments may be provided.

In some embodiments, an activity based working (ABW) work style may be defined as one in which spaces are allocated based on work activity. Accordingly, activity based workspaces are open addressed having focus areas, collaborative work areas, and social areas. Each of the areas may be distinct and freely adaptable as a workspace. In the ABW work style, desks may not be provisioned to correspond to 100% of the headcount, as individuals may migrate to different work areas depending on the current work activity that the individual is assigned.

In some embodiments, a collaborative work style may be defined as one in which each individual is assigned a desk, and may include contiguous formal and informal collaboration spaces. Work desks may flow into open or semi-enclosed informal collaboration spaces and formal collaboration areas.

In some embodiments, a collaboratory work style may be defined as one in which the primary work area functions as a meeting space or table. The collaboratory work style allows for individual and group work collaboration to occur seamlessly between teams at the meeting space or table. Longer collaborative activities may be moved into designated collaboration areas.

In some embodiments, co-working work style may be defined as an ABW workstyle with a rustic and easy feel. The co-working work style may have the ambience and nuance of a start-up, where everyone and everything comes together to address a work task.

In some embodiments, the work style data point may be used in combination with the work culture data point (e.g., as a matrix) to further help define the types of spaces, space layout, spatial placement, and attributes for each of the spaces in the workplace environment design. In some embodiments, the platform via the knowledge base, rules and/or machine learning may use the work style data point to determine any of the elements of the project plan or functional list for the workplace design, such as to define the types of spaces, space layout, spatial placement, and attributes for each of the spaces in the workplace environment design. In some embodiments, the work culture/work style combination may be limited based on the work culture input by the user at FIG. 3B. For example, depending on the work culture data point input by the user at FIG. 3B, the types of work style that the user can select may be limited or reduced. For example, a traditional work culture may be combined with only a collaborative work style, whereas an innovative work culture may be combined with any of the work styles. However, the present invention is not limited thereto.

Referring to FIG. 3D, according to some embodiments, the questionnaire 202 may prompt the user to select or describe a space experience 308 for each of the spaces (or areas) of the workspace environment. For example, in some embodiments, the workspace environment may be split into five types of spaces or areas including reception and external meeting suites, open office work area, enclosed offices, meeting room and informal collaboration area, and social area (e.g., pantry, break rooms, and the like). However, the present disclosure is not limited to the number or types of spaces shown in FIG. 3D. Each of the space types may correspond to one or more spatial categories of the workspace environment, so that a different look and feel can be applied for each of the space types.

In some embodiments, the types of space experiences may include modern, homely, quirky, contemporary, classic, rustic, industrial, casual, Zen, and minimal. However, the present disclosure is not limited to the number or types of space experiences as shown in FIG. 3D. The space experience data point defines the look and feel (e.g., décor, furniture, lighting, and the like) for each of the space types and corresponding spatial categories. In some embodiments, the platform via the knowledge base, rules and/or machine learning may use the space experience data point to determine any of the elements of the project plan or functional list for the workplace design, such as the look and feel of the space.

Referring to FIG. 3E, according to some embodiments, the questionnaire 202 may prompt the user to select or describe the desired health focus 310 of the workspace environment. For example, the desired health focus may include wellness or sustainability. In some embodiments, the health focus data point may be used to select office equipment and/or for automatic filtering of the 3^{rd} party catalogue. For example, if wellness is selected, the office equipment designed for ergonomics may be selected/filtered, whereas as if sustainability is selected, the office equipment designed for environmentally friendly products or finishes may be selected/filtered. However, the present disclosure is not limited thereto, and in some embodiments, this prompt of the questionnaire 202 may be omitted. In some embodiments, the platform via the knowledge base, rules and/or machine learning may use the health focus data to determine any of the elements of the project plan or functional list for the workplace design, such as the look and feel of the space.

Referring to FIG. 3F, according to some embodiments, the questionnaire 202 may prompt the user to specify or provide a budget, such as the budget 312 on a per square feet basis. However, the present disclosure is not limited thereto, and in some embodiments, the questionnaire 202 may prompt the user for the total budget instead of the budget per square feet, in which case, the workplace strategy interface 200 may calculate the budget 312 per square feet based on the total budget if necessary or desired.

In some embodiments, the questionnaire may allow the user or customer to provide input on items to be included or excluded in the budget. In some embodiments, the budget may include various inclusions 314, for example, such as furniture, partitions, chairs, branding, lighting, air-conditioning, audio visuals, IT active, IT passive, flooring, telephones, security, white goods, and the like. However, the present disclosure is not limited thereto, and the various inclusions may include more or less than those shown in FIG. 3F. In some embodiments, the questionnaire 202 may allow the user to input 316 or describe additional inclusions to be included in the budget, or to remove inclusions from the budget as desired.

Referring to FIG. 3G, according to some embodiments, the questionnaire 202 may prompt the user to provide input on a number of headcount to consider for the design, such as input a breakdown of the headcount 318 for each department 320 in the workspace environment. Here, the user may add 322 or delete 342 departments 320 as needed or desired, and may specify a workstyle 324 and work culture 326 for each of the departments 320 (e.g., if different from the overall workstyle and culture that was previously provided in the prompts for FIGS. 3B and 3C). The questionnaire 202 may prompt the user for input on headcount by any grouping of users, such as department, groups, functions or location. The questionnaire 202 may prompt the user for input on headcount by space or room type or by size of room or style of room (e.g., open, enclosed). The questionnaire 202 may prompt the user for input on headcount by role or title of users.

In some embodiments, the user may specify whether any of the departments are secluded 328 (e.g., in a secluded area within the workspace environment). For example, in the case where the department is to be located at an area of the workspace environment that requires special authorization or clearance to access, the area may be specified as being secluded.

In some embodiments, for each department, the user may further specify a number of individual contributors in an open area 330, and a number of managers in each of the open area 332, small enclosed room 334, or large enclosed room 336. In some embodiments, the user may further specify a mobility percentage 338 and a density benchmark 340 for each department 320. The mobility percentage 338 may indicate a percentage of a corresponding headcount that is considered mobile either part-time or full-time or otherwise a mobile worker. The mobility percentage 338 may indicate a percentage of a headcount for the corresponding department that is expected to work from different areas or locations (e.g. mobile), and thus, may not require an assigned desk or workspace. The density benchmark 340 may indicate a relative density of headcount for a space, department or other group of users. The density benchmark may be specified or selected as below, above or at a standard benchmark, such as for users or customer for any one or combination of sector, work style and/or culture. In some embodiments, the density benchmark 340 may indicate growth potential of the headcount for the space, or may indicate the amount of space that should be allocated for the headcount.

Referring to FIG. 3H, according to some embodiments, the questionnaire 202 may prompt the user to input a number and/or type of specialty spaces 344 that should be allocated in the workspace environment. The questionnaire 202 may prompt the user to input in which parts or areas of the office space or design each of the specialty spaces should be included. In some embodiments, the user may specify how many of each type of specialty spaces should be allocated for the general office area 346 and for the secluded office area(s) 348. Some non-limiting examples of the specialty spaces may include server rooms, hub rooms, labs, data centers, and the like. However, the present disclosure is not limited to the number or types of the specialty space examples shown in FIG. 3H.

Referring to FIG. 3I, according to some embodiments, the questionnaire 202 may prompt the user to describe the real estate 350 for the workspace environment by inputting the net or total amount of internal space 352, and to input or upload a floorplan 354 of the internal space. In some embodiments, the user may already have acquired the internal space for the workspace environment or has access to such information and can either upload or create and upload a suitable floorplan. In some embodiments, if the user indicates that an internal space for the workspace environment has not yet been acquired 356, the workplace strategy interface 200 may calculate or infer a suitable net internal area and/or floorplan to generate the project plan or functional list. The user can refer to the generated functional list and/or generated spatial plan views to determine the amount of internal space and/or floorplan that should be acquired to implement the workspace environment design.

Upon capturing customer business requirements for the workplace design via the online questionnaire, the project needs are automatically analyzed by the platform based on the knowledge base and rules, and a project plan is generated that is designed, specified and/or optimized for the customer needs. The automatically generated project plan may include or specify any of the following: all required functional blocks for the different categories (e.g. work point, collaboration, break out, front of house, support, etc.) with recommended quantities and attributes (PAX, spatial proximity, etc.), calculated area based on an optimization process maximizing utilization of space based on customer/project needs, taking into consideration circulation requirements and building efficiency calculated air-conditioning requirements to support spaces in the design and calculated power requirements to support lighting and integrated technology.

In some embodiments, the platform via the knowledge base may use any combination of the data input from the questionnaire to form a customer or user profile and to determine any of the elements of the project plan or functional list for the workplace design or any output of the design workplace, such as based on the sector, culture and style data points. The platform may apply rules to data in the knowledgebase to automatically select any elements for the design workplace using questionnaire responses as input to the rules and selection from the knowledgebase. The platform may apply rules to data in the knowledgebase to automatically select, place, size, configure, modify and/or display any of the space elements in the design workplace. The knowledgebase may include any rules and data related to, associated with, supported by or required for any of the modules or components or services of workplace strategy interface 200, planning and zoning 210, engineering services 215, interactive design and cost manager 220, product and marketplace integrator 225, and operations manager 260 and 3^{rd} party product marketplaces 275. The knowledgebase may include any rules and data related to any legal requirements, office space, zoning or other law and regulations based on location, geography, city, state or country.

In some embodiments, the platform may use the machine learner and analyzer 250 to determine any of the elements of the project plan or functional list for the workplace design or any other elements of the design, such as based on the sector, culture and style data points. The machine learner and analyzer 250 may be designed, constructed and configured to use and analyze any data, inputs, results or output of using the platform, such as previous workspace designs and create one or more models or templates. The machine learner and analyzer 250 may classify any data, inputs, results or output into one or more classification schemes or models. The machine learner and analyzer 250 may classify any of the customer profiles or questionnaire responses into one or more models based on designs resulting from such customer profiles or questionnaire responses. The machine learner and analyzer may take as input a customer profile or questionnaire responses and determine any of the elements of the project plan or functional list for the workplace design based on such input and classification and/or modeling of past designs.

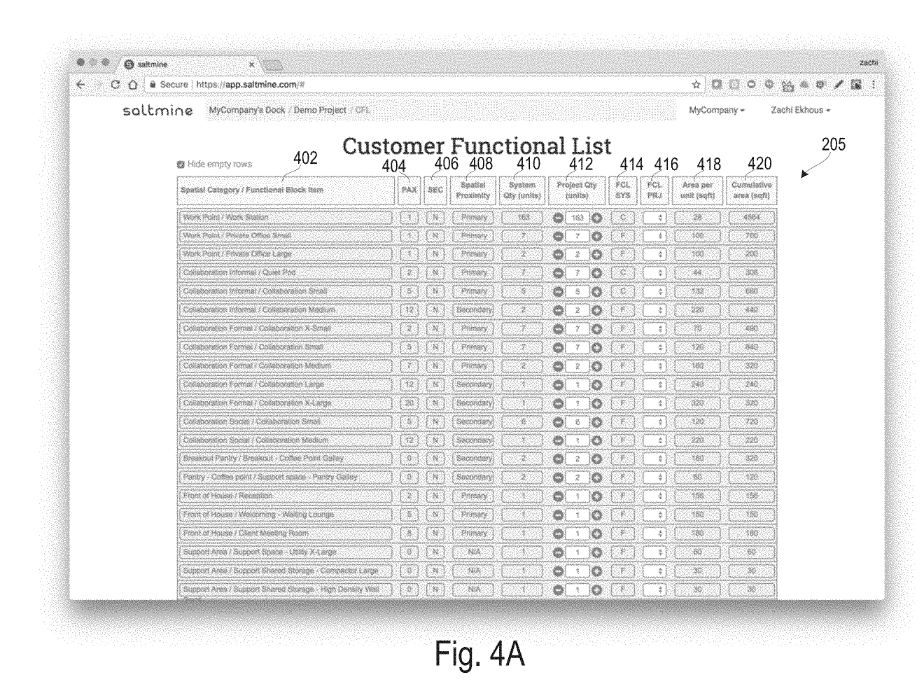

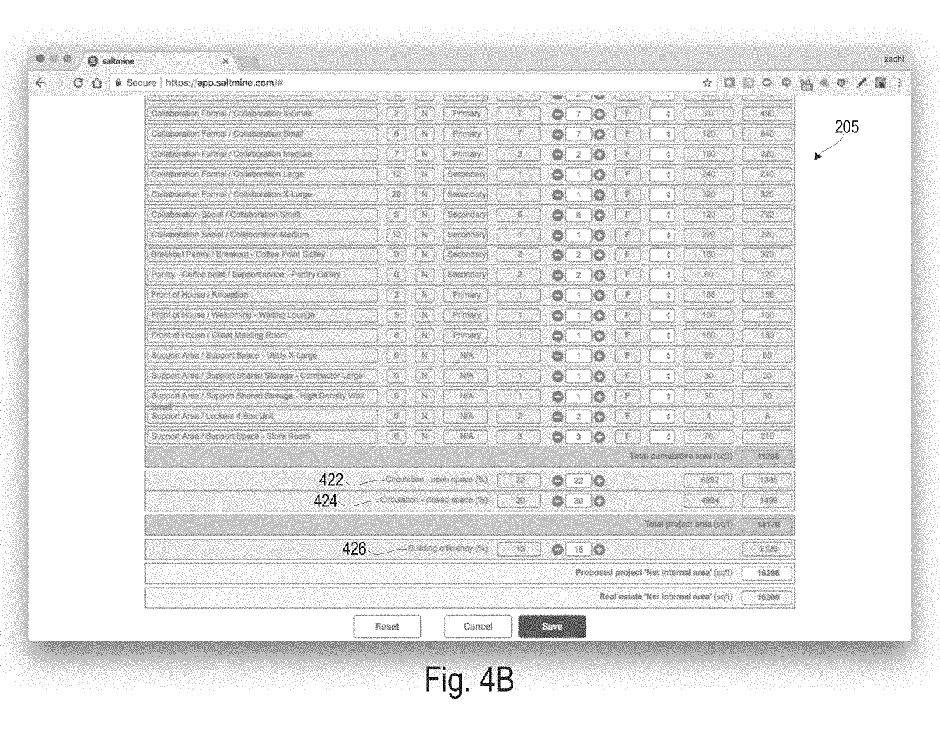

FIGS. 4A and 4B show an example project plan or customer functional list, according to some embodiments. In some embodiments, the workplace strategy interface 200 analyzes the input responses to the questionnaire 202, to generate the customized project plan or customer functional list (CFL) 205 for the workspace environment. Referring to FIGS. 4A and 4B, the CFL 205 includes a list of a plurality of spatial category/functional block items (collectively “functional blocks”) 402. Each of the functional blocks may represent one or more spaces within the workspace environment. In some embodiments, the functional blocks may be used to graphically generate the spatial plan views (e.g., 2-D, 3-D, and/or VR) of the workspace environment.

The following are non-limiting examples of predefined blocks:

Block

| ID | Category | Type | PAX |
|---|---|---|---|
| 001 | Work Point | Work Station | 1 |
| 003 | Work Point | Private Office Small | 1 |
| 059 | Work Point | Private Office Large | 1 |
| 005 | Collaboration Informal | Quiet Pod (1/2) | 2 |
| 006 | Collaboration Informal | Collaboration Small | 4 |
| 007 | Collaboration Informal | Collaboration Small | 5 |
| 008 | Collaboration Informal | Collaboration Medium | 8 |
| 009 | Collaboration Informal | Collaboration Medium | 12 |
| 010 | Collaboration Formal | Collaboration X-Small | 2 |
| 011 | Collaboration Formal | Collaboration Small | 4 |
| 012 | Collaboration Formal | Collaboration Small | 5 |
| 013 | Collaboration Formal | Collaboration Small | 6 |
| 014 | Collaboration Formal | Collaboration Medium | 7 |
| 015 | Collaboration Formal | Collaboration Medium | 8 |
| 016 | Collaboration Formal | Collaboration Medium | 9 |
| 017 | Collaboration Formal | Collaboration Medium | 10 |
| 018 | Collaboration Formal | Collaboration Large | 12 |
| 019 | Collaboration Formal | Collaboration Large | 16 |
| 020 | Collaboration Formal | Collaboration X-Large | 20 |
| 021 | Collaboration Formal | Collaboration X-Large | 24 |
| 022 | Collaboration Social | Collaboration Small | 4 |
| 023 | Collaboration Social | Collaboration Small | 5 |
| 024 | Collaboration Social | Collaboration Medium | 8 |
| 025 | Collaboration Social | Collaboration Medium | 12 |
| 026 | Breakout - Pantry | Breakout - Coffee Point Side Board | 0 |
| 027 | Breakout - Pantry | Breakout - Coffee Point Island | 0 |
| 028 | Breakout - Pantry | Breakout - Coffee Point L Counter | 0 |
| 029 | Breakout - Pantry | Breakout - Coffee Point Galley | 0 |
| 030 | Pantry | Support space - Pantry Side Board | 0 |
| 031 | Pantry | Support space - Pantry Island | 0 |
| 032 | Pantry | Support space - Pantry L Counter | 0 |
| 033 | Pantry | Support space - Pantry Galley | 0 |
| 034 | Front of House | Reception | 1 |
| 035 | Front of House | Reception | 2 |
| 043 | Support Area | Support Space - Utility Small | 0 |
| 044 | Support Area | Support Space - Utility Medium | 0 |
| 045 | Support Area | Support Space - Utility Large | 0 |
| 046 | Support Area | Support Space - Utility X-Large | 0 |
| 047 | Support Area | Support Shared Storage - Compactor Small | 0 |
| 048 | Support Area | Support Shared Storage - Compactor Large | 0 |
| 049 | Support Area | Support Shared Storage - High Density Wall Small | 0 |
| 050 | Support Area | Support Shared Storage - High Density Wall Large | 0 |
| 051 | Support Area | Lockers 3 Box Unit | 0 |
| 052 | Support Area | Lockers 4 Box Unit | 0 |
| 053 | Support Area | Lockers 5 Box Unit | 0 |
| 054 | Support Area | Support Space - Store Room | 0 |
| 055 | Speciality Spaces | Server Rooms | 0 |
| 056 | Speciality Spaces | Hub Rooms | 0 |
| 057 | Speciality Spaces | Labs | 0 |
| 058 | Speciality Spaces | Data Centres | 0 |

Each block item may have different representation for different combinations of Culture and Work-style. In some embodiments, one or more specific blocks may have 3 different versions for the 3 different area fits (Function/Comfort/Luxury).

In some embodiments, the work culture and work style inputs from the questionnaire 202 (e.g., FIGS. 3B and 3C) may be used to determine which ones of the functional blocks from among a plurality of predefined blocks are included in the CFL 205. For example, based on the work culture/work style combination, some of the predefined blocks may be selected to be included in the CFL 205 while others may be omitted. In some embodiments, components (e.g., area, equipment, furniture, floor plan, and the like) within the predefined blocks may be variously changed according to the various possible combination of inputs to the questionnaire 202. In some embodiments, the predefined blocks are selected based on or according to the budget specified via the questionnaire. The predefined blocks may have multiple variations to meet or fit within budget specifications or ranges. The predefined blocks may also be grouped together according to different budget options. For example, a first group of one or more predefined blocks or variants thereof may be associated with or for a first budget amount or range while a second group of one or more predefined blocks or variants thereof may be associated with or for a second budget amount or range

In some embodiments, various attributes may be assigned for each of the functional blocks based on the inputs to the questionnaire 202, and at least some of the attributes may be modified or specified by the user. For example, in some embodiments, the attributes may include PAX 404, SEC 406, spatial proximity 408, system quantity (Qty) 410, project quantity (Qty) 412, FCL SYS 414, FCL PRJ 416, area per unit 418, and cumulative area 420. PAX 404 represents, specifies or identify the number of persons or seats that can occupy or is designed to occupy the space represented by the functional block. SEC 406 defines whether the space should be located in a secluded area within the workspace environment. Spatial proximity 408 defines, identifies or specifies the proximity relative to or in space of one item in the design to another item in the design, such as how close the functional block should be placed at or near another area, such as main work area or open office. In some embodiments, spatial proximity is identified as a primary or secondary item to determine priority in placement of the item, such as a functional block in a corresponding space. System Qty 410 is a quantity, such as the recommended quantity of the functional block in the workspace environment design based on the analysis of the inputs to the questionnaire 202. Project Qty 412 is the actual quantity of the functional block that will be used in the workplace environment design, as modified by the user.

FCL SYS 414 is the foot print area, such as the recommended foot print area, of the functional block corresponding to different area fits based on density. For example, each of the predefined blocks may have different versions corresponding to the different area fits based on density, where function (F) represents the smallest foot print, comfort (C) represents a larger foot print, and luxury (L) represents the largest foot print. FCL PRJ 416 is an upgraded or optimized (e.g., from function to comfort to luxury) footprint area of the functional block based on an automatic optimization algorithm or user definition, to maximize usage of space and to reduce or minimize unused space.

In a non-limiting example, the algorithm may include any of the following logic, functions or steps:
Real estate Net Internal Area is split between the different departments (as defined in the headcount breakdown) based on department headcount and density.
Split also take care for common and external spaces.

### Per Department/Common/External:

Filter block list by Culture;
Assign block attributes by Culture/Workstyle;
Calculate recommended quantity per block—each category may have different logic, some dependent on other categories calculation;
Calculations uses input dimensions and rely on workplace strategy parameters—culture/workstyle/project-scale specific (e.g. collaboration spaces ratios, distribution between different collaboration families/sizes, etc.);
Each block is assigned with a default Area Fit based on Density (input);
All blocks are optimized—trying to find the best combination of Area Fit for all blocks that minimize residual space;
   Optimization algorithm has priorities for categories/items based on Culture;
Circulation space is calculated based on cumulative area of blocks, separated automatically to open/closed spaces (e.g. workstation vs formal meeting room);
   Actual ratio of circulation for open/closed is derived from total area and headcount;
Building efficiency space is calculated based on cumulative area of blocks and circulation;
   Actual ratio of building efficiency is derived from total area and headcount; and
Aggregated block list is generated from all department and common and external spaces.

For example, in some embodiments, the optimization algorithm may automatically upgrade a functional block (e.g., function to comfort to luxury) based on a criteria, such as a priority. The priority may be determined from a combination of the spatial category and the work culture, where different combinations have different priorities. For example, different work cultures may have different upgrade priorities for the spatial categories. In some embodiments, if a functional block cannot be upgraded because of space constraints, the next priority may be selected for upgrade. By way of example, the following is a portion of an implementation of a table representative of an algorithm to improve, maximize or optimize usage of space by upgrading functional blocks area fit based on culture and priorities:

| | Culture | | |
|---|---|---|---|
| Spatial category | Innovation | Startup | Traditional |
| Work point | 1 | 1 | 2 |
| Informal Collaboration | 1 | 2 | 2 |
| Formal Collaboration | 2 | 2 | 1 |
| Social Collaboration | 2 | 1 | 3 |
| Breakout-Pantry | 2 | 1 | 3 |

However, the present disclosure is not limited thereto, and in some embodiments, the functional block may be upgraded based on user selection or based on machine learning of past designs.

The area per unit 418 is the area of a functional block based on the area fit (e.g., function, comfort, and luxury). The cumulative area 420 is the total area of the functional block based on the system Qty 410 or project Qty 412 and the area per unit 418. While FIG. 4A shows the unit of measurement for the area per unit 418 and the cumulative area 420 as square-feet, the present disclosure is not limited thereto, and any suitable unit of measurement may be used.

In some embodiments, the CFL 205 may further include space allocations for circulation—open space 422, circulation—closed space 424, and building efficiency 426. The circulation spaces 422 and 424 defines the amount of space that should be allocated for circulation paths around workspace environment for each of the open spaces 422 (e.g., work stations) and closed spaces 424 (e.g., formal meeting rooms). The circulation spaces 422 and 424 may be automatically generated and/or set/modified by the user. The circulation space may generally be derived from the total area of the open space, the total area of the closed space, and headcount. The building efficiency 426 specifies or identifies the efficiency in use of space, such as the amount of space used for the office design to the amount of space in the building, unit or floor. In some embodiments, the building efficiency is the leasable or occupied space as a percentage of the total square footage of the building, unit or floor. The building efficiency 426 is a percentage of the total space (including the cumulative space for the functional blocks and the circulation space) that should be included in the proposed project net internal space area.

Accordingly, the CFL 205 provides a project plan list of each of the spaces represented by functional blocks that are to be included in the workspace environment design. The CFL 205 may be used to generate the spatial plan views of the workspace environment design, and each of the functional blocks may be further customizable by the user as needed or desired.

### Planning and Zoning

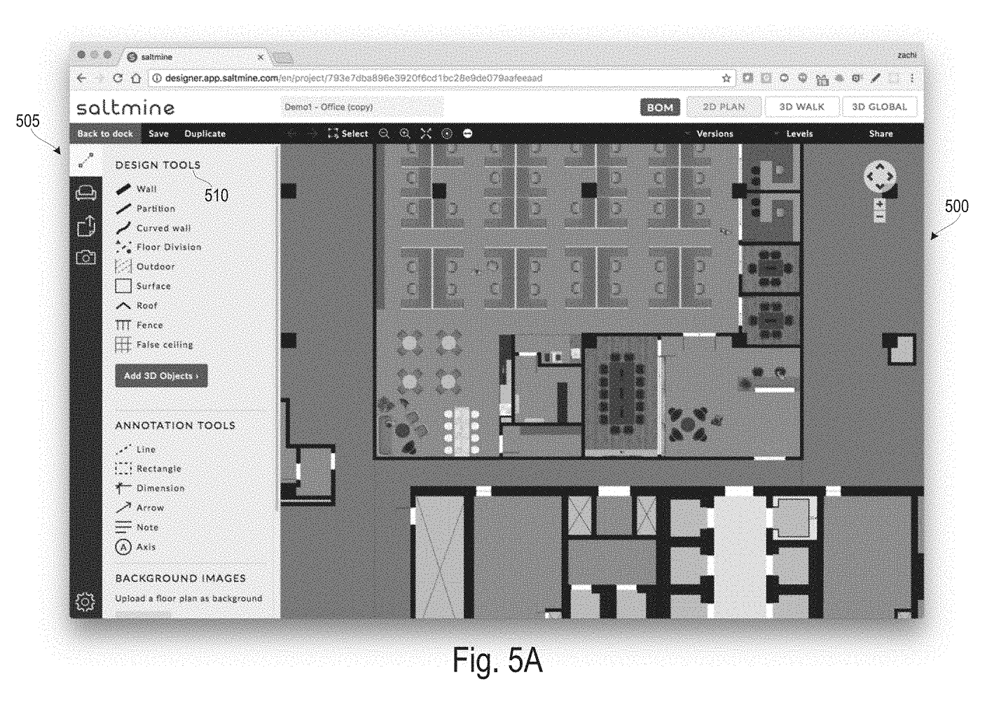

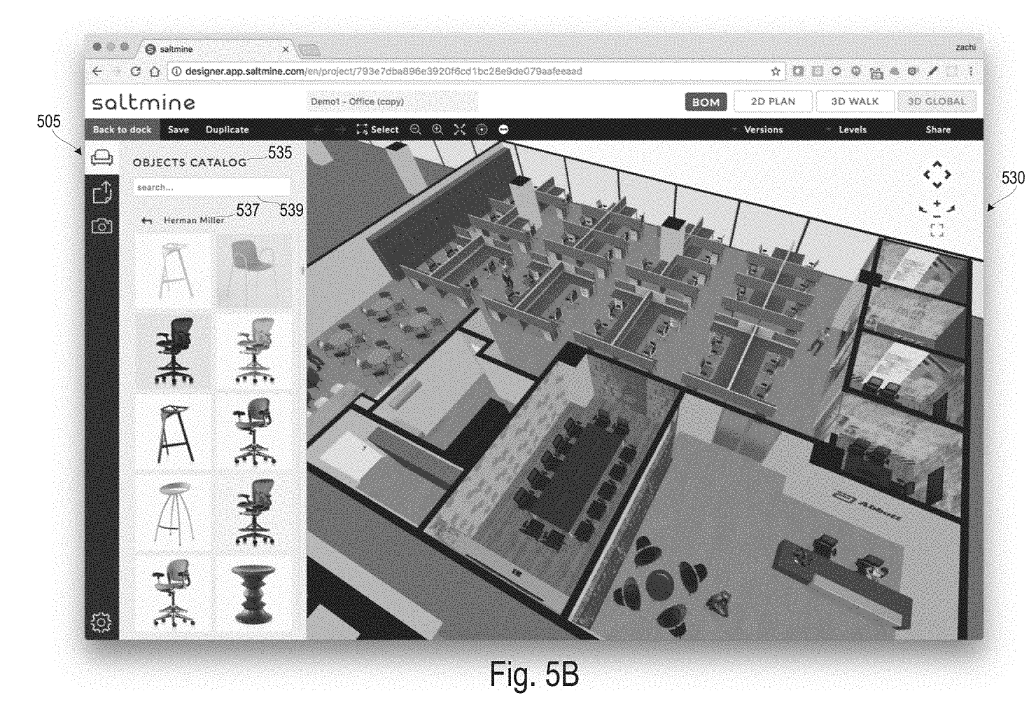

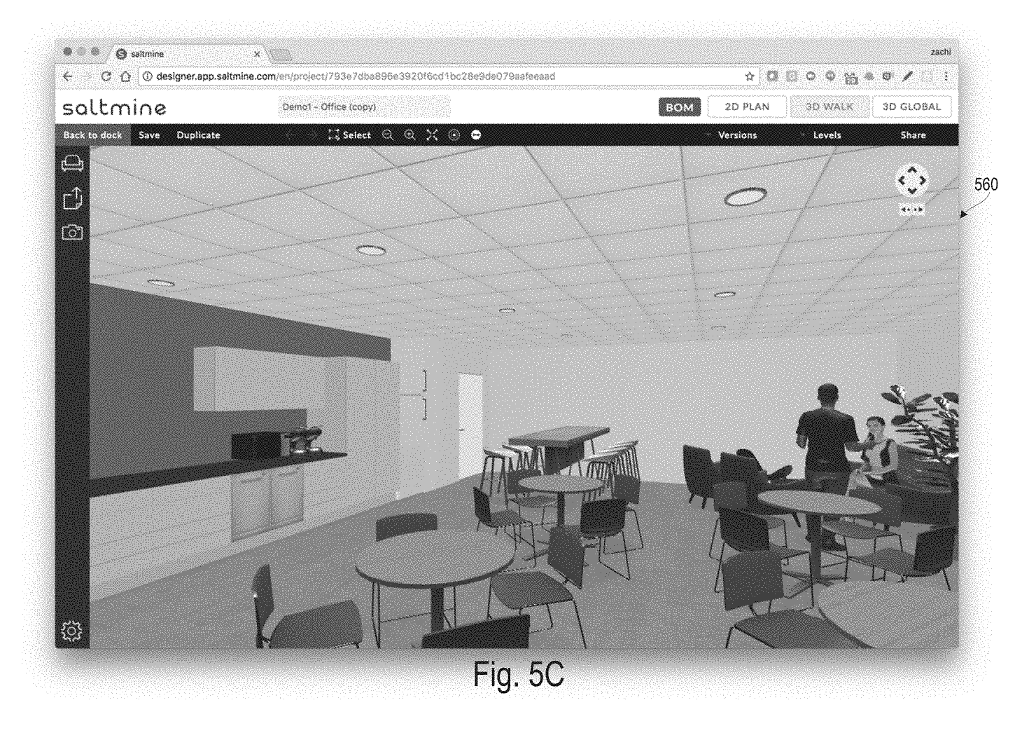

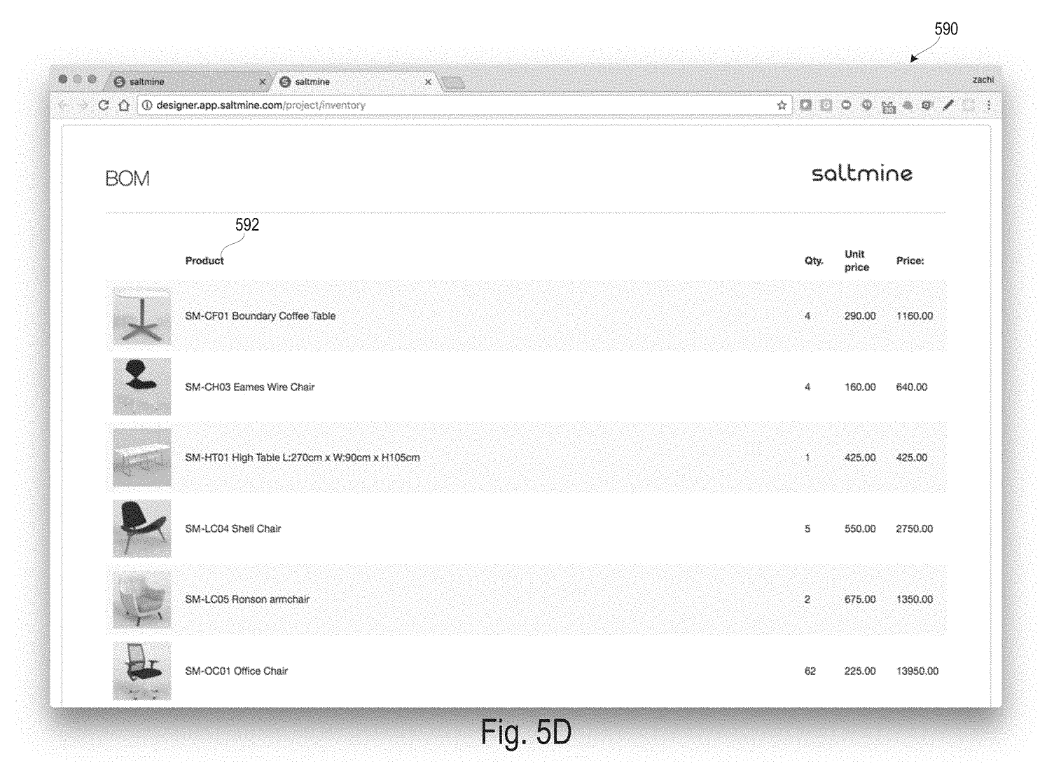

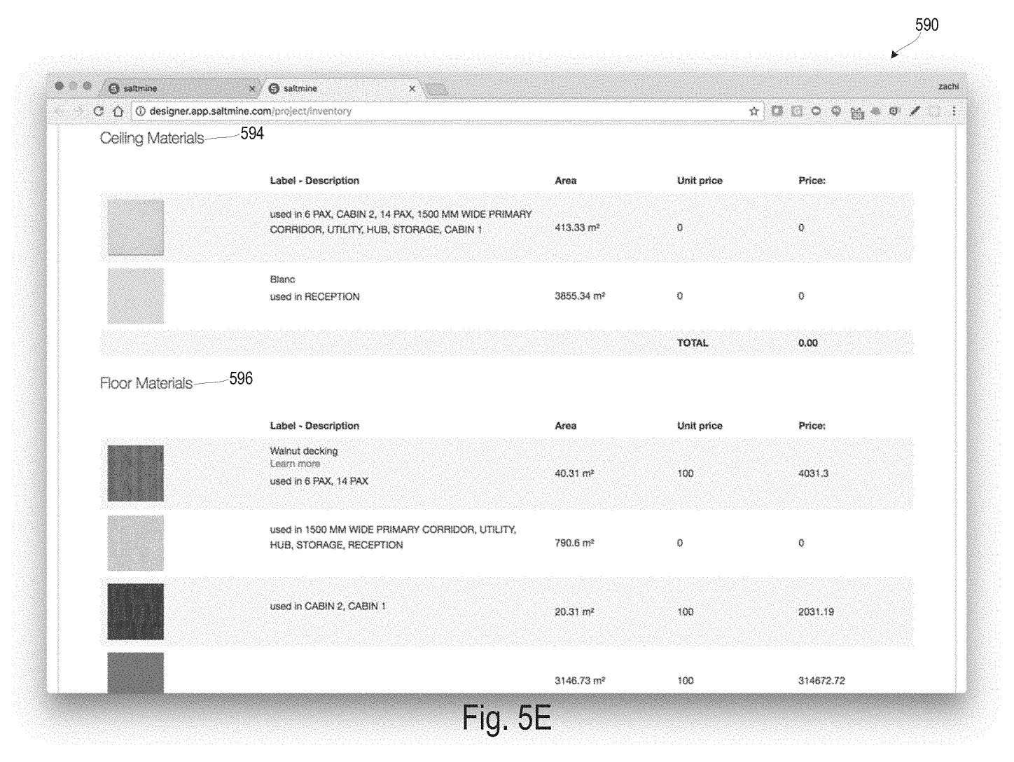

FIGS. 5A through 5C illustrate various spatial plan views of the workspace environment design according to some embodiments. In some embodiments, planning and zoning 210 may automatically generate a graphical 2-D spatial plan view 500 as shown in FIG. 5A, a graphical 3-D spatial plan view 530 as shown in FIG. 5B, and/or a graphical VR walk through view 560 as shown in FIG. 5C. In some embodiments, any modifications to any of the elements or components in one of the spatial plan views may be automatically reflected (e.g., in real-time or near real-time) in each of the spatial plan views.

In some embodiments, planning and zoning 210 may automatically generate the spatial plan views 500, 530, and 560 of the workspace environment based on customized knowledge base and rules for spatial placement, adjacency priorities, and constraints, while implementing the user-defined work culture, work style, look and feel, available space, floorplan, and the like. The planning and zoning 210 may use the knowledgebase by applying rules to information in the knowledgebase for performing, providing and considering spatial placement, adjacency priorities, and constraints. For example, planning and zoning 210 may generate the spatial plan views 500, 530, and 560 based on predefined functional blocks corresponding to the customized CFL 205 and the user inputs to the questionnaire 202. In some embodiments, planning and zoning 210 may generate graphical plan views for each of the functional blocks based on the work culture, work style, and space experience for each of the spaces (or areas), and may automatically arrange the plan views graphically of each of the functional blocks based on the various attributes for the functional blocks in the customized CFL 205, available space, and floorplan. However, the present disclosure is not limited thereto, and in some embodiments, planning and zoning 210 may generate the plan views for each of the functional blocks, and the plan views may be manually drag-and-dropped by the user in a graphical interface or arranged according to any suitable method.

### Engineering Services

According to some embodiments, engineering services 215 may automatically analyze and incorporate various engineering elements, services, and requirements into the workspace environment design. For example, heating, ventilation, and air-conditioning (HVAC) systems and requirements for the various spaces, and power requirements for lighting, equipment, integrated systems, and the like may be automatically analyzed, calculated, and incorporated into the workspace environment design. The engineering services 215 may use the knowledgebase by applying rules to information in the knowledgebase for performing, providing and considering any of various engineering elements, services, and requirements into the workspace environment design. In some embodiments, engineering services 215 may provide comprehensive tools to generate and visualize reflected ceiling plans (RCP). The RCP may include, for example, ceiling architecture, ceiling elements (lights, air vents, sprinklers, smoke detectors, and the like), ceiling tiles and finishes, and the like. The RCP may be visualized in 2-D and 3-D as an integrated layer of planning and zoning 210. In some embodiments, an extensive catalogue containing predefined blocks of the RCP elements may be provided with integrated technology solutions (e.g., IT, AV, and the like).

### Interactive Design and Cost Manager

In some embodiments, interactive design and cost manager 220 may provide an interactive design tool 505 to support the 2-D, 3-D, and/or VR visualizations. In some embodiments, interactive design and cost manager 220 may provide a rich catalog 535 of predefined blocks, products and furniture, materials and finishes, branding materials, and the like, that is managed by interactive design and cost manager. The design and cost manager may use the knowledgebase by applying rules to information in the knowledgebase for performing, providing and considering any of predefined blocks, products and furniture, materials and finishes, branding materials, and the like. In some embodiments, interactive design and cost manager 220 may provide interactive drawings tools 510 to allow the user to drag-and-drop predefined blocks and elements therein (e.g., walls, doors, furniture, finishes, integrated technologies, and the like) into the workspace design. In some embodiments, any of the additions, deletions, and modifications may be automatically updated in each of the spatial plan views 500, 530, and 560 (e.g., via planning and zoning 210).

For example, referring to FIG. 5A, interactive design and cost manager 220 provides various interactive drawing tools 510 to modify, add, or delete various elements (e.g., walls, doors, ceilings, and the like) within the workspace design. As another example, referring to FIG. 5B, interactive design and cost manager 220 provides an object catalog 535 to swap out or add furniture from a variety of sources (e.g., 3^{rd} party vendors). In some embodiments, the available products and furniture may be automatically filtered based on available budget or based on user requirements. For example, depending on the user's input to the health prompt 310 (FIG. 3E) of the questionnaire 202, the available products and furniture may be automatically filtered to include wellness related products or sustainability related products (as the case may be), where available and/or feasible from a budget perspective.

In some embodiments, interactive design and cost manager 220 provides overall cost and budget management services, and may generate a BOM 590 for the overall design. For example, referring to FIGS. 5D and 5E, which illustrate a bill of materials (BOM) 590 for the workspace environment design, interactive design and cost manager 220 analyzes the overall design including the costs of products and furniture 592, ceiling materials 594, flooring materials 596, equipment, and the like, and generates the BOM 590. In some embodiments, the BOM 590 is automatically updated when changes to the blocks and components are made in the questionnaire 202, CFL 205, and/or any of the spatial plan views 500, 530, and 560. Accordingly, interactive design and cost manager 220 may help to manage costs to maintain the project budget.

### Product and Marketplace Integrator

Referring again to FIGS. 2 and 5B, in some embodiments, product and marketplace integrator 225 is connected to a variety of 3^{rd} party vendors (e.g., 537) to generate a product catalog 227 (e.g., objects catalog 535). In some embodiments, the product catalogues may be automatically filtered based on the user's needs, budget, and requirements. For example, in some embodiments, 3^{rd} party vendors may register with product and marketplace integrator 225 to offer its products to potential consumers and users of the workspace design cloud platform 120. In some embodiments, product and marketplace integrator 225 may offer goods from various 3^{rd} party vendors regardless of price, and the user may select the desired goods to be used in the workspace environment design. In some embodiments, product and marketplace integrator 225 may automatically filter goods based on price, and may offer those goods fitting within a price range or criteria. In some embodiments, product and marketplace integrator 225 may automatically filter goods based on available budget, and may offer those goods that can meet the available budget. In some embodiments, the user may select one or more filters (e.g., based on brand, product type, price, available quantity, and/or the like), and product and marketplace integrator 224 may filter the goods to those that satisfy the one or more user-defined filters. In some embodiments, the user may search 539 for a particular product or brand, and product and marketplace integrator 224 may return a list of goods that match (or best match) the search 539.

In some embodiments, product and marketplace integrator 225 may solicit or receive bids from competing 3^{rd} party vendors who wish to become recommended or preferred vendors, and product and marketplace integrator 225 may initially recommend or filter the goods to those of the recommended or preferred vendors. For example, product and marketplace integrator 225 may select the 3^{rd} party vendor whose bid satisfies some criteria, for example, the lowest price, expected delivery date, quantity, warranty, or some other suitable criteria, and may initially filter the product offerings to the goods of the selected 3^{rd} party vendor. In some embodiments, product and marketplace integrator 225 may send out an order or request for bids having one or more specified criteria (e.g., type of goods, price, quantity, expected delivery date, and/or the like) to various 3^{rd} party vendors, and the 3^{rd} party vendors may accept or decline to fill the order, may bid against each other to fill the order, or may respond with a counter bid.

### Operations Manager

In some embodiments, operations manager 260 may be designed, constructed and configured to analyze the utilization, activities and patterns of use of the work space as deployed or as being used. The operations manager may receive input such as via a user interface to identify number of people or headcount using the space versus capacity, such as on a per area, per room or overall space usage. The operations manager may receive input such as via a user interface to identify the type of activities for which certain areas or functional blocks are being used versus for which they were designed. The operations manager may receive input such as via a user interface to identify lack of use or patterns of use for specific areas. The operations manager may receive input such as via a user interface to identify whether or not the space is being utilized efficiently or as desired. The operations manager may receive input via any type and form of sensors, such as Internet of Things based sensors or Internet enabled sensors. Such sensors may provide information on the utilization, activities and patterns of use of the work space, including occupancy, non-occupancy, length of occupancy, number of occupants, time of use and any ambient information, such as temperature, humidity, etc. The operations manager may have an API interface and/or any type and form of integration with the sensors or devices with sensors themselves or to a system or platform that provides sensors and information from the sensors. The operations manager may use any such input to analyze or optimize the utilization or design of the work space. The operations manager may make recommendations or suggestions of changes to any of the elements based on the input, such as using the knowledgebase and/or rules and/or via machine learning algorithms.

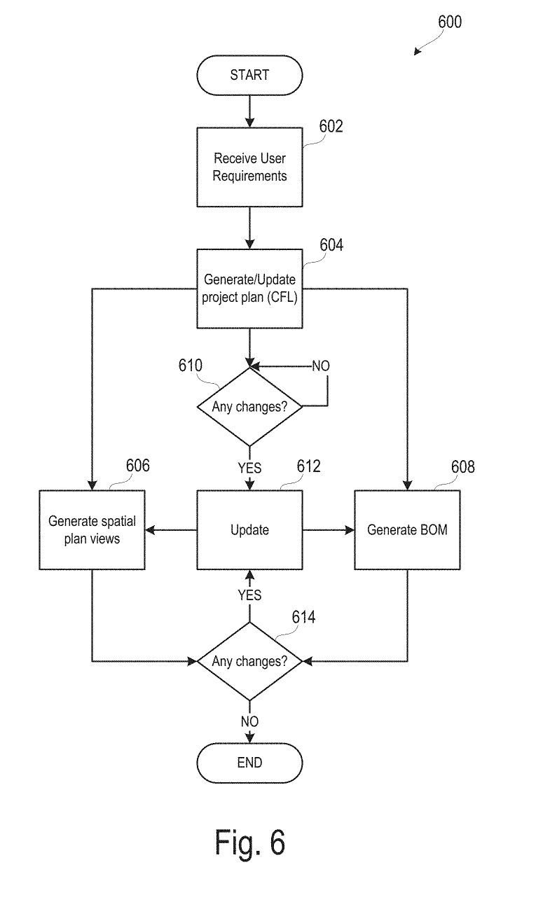

FIG. 6 is a flow diagram of a method for propagating changes or modifications throughout the various stages of the workspace environment design, according to some embodiments. Referring to FIG. 6, the process 600 starts and workplace strategy interface 200 receives user inputs and requirements at block 602. For example, the user inputs and requirements may be received in response to the questionnaire 202. In some embodiments, the user inputs and requirements that are received at block 602 may be requirements for a new project, in which case, workplace strategy interface 200 generates the project plan or customer functional list 205 at block 604 based on the user inputs and requirements for the new project. In some embodiments, the user inputs and requirements at block 602 may be modifications to an existing project, in which case workplace strategy interface 200 updates the existing project plan or customer functional list 205 at block 604 based on the modified user inputs and requirements for the existing project.

In response to the project plan or customer functional list 205 being generated at block 604, planning and zoning 210 generates spatial plan views at block 606 and interactive design and cost manager 220 generates BOM at block 608, based on the generated CFL 205. If the CFL 205 was updated or modified at block 610, both the spatial plan views and the BOM are updated at block 612. Further, if there are any updates or modifications to either one of the spatial plan views or BOM at block 614, the other of the spatial plan views and the BOM are updated at block 612. If there are no more updates or modifications at block 614, the process ends.

Accordingly, in some embodiments, any additions, modifications, or deletions at any stage (e.g., the questionnaire 202, CFL 205, spatial plan views, or BOM) at any time during the project lifecycle of the workplace environment design may result in automatic propagation of the changes throughout the entire project in real-time or near real-time. Thus, the project timeline may be reduced, and productivity and collaboration may be improved.

The workplace design cloud platform 120 may integrate and/or interface any of the workplace strategy interface 200, planning and zoning 210, engineering services 215, interactive design and cost manager 220, product and marketplace integrator 225, and operations manager 260, such that any change in one of these services, components or modules is automatically propagated to all or any of the other services, components or modules. As such, workplace design cloud platform 120 allows and enables a non-linear approach to the design process as user can change any element in one service, component or module and seamlessly go to another service, component or module and see the impact or results of the change, including any changes to design elements, overall design, costs and/or budget, including updates to any 2D, 3D or virtual reality views.

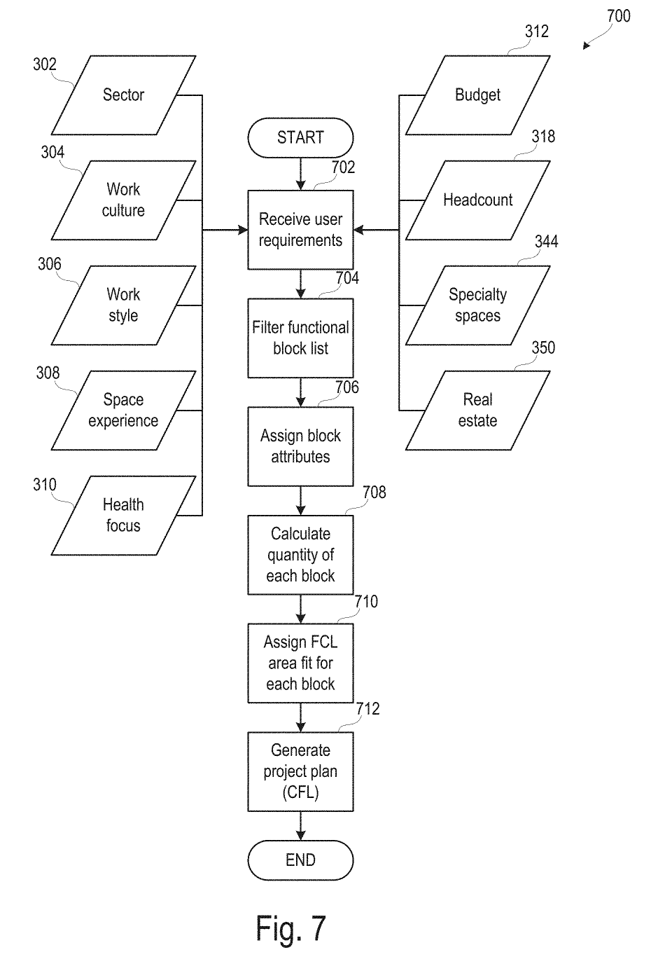

FIG. 7 is a flow diagram of a method for generating a project plan or customer functional list based on user requirements, according to some embodiments. Referring to FIG. 7, the process 700 starts and workplace strategy interface 200 receives user inputs and requirements at block 702. For example, workspace strategy interface 200 may receive the user inputs and requirements in response to the questionnaire 202. The user inputs and requirements may include, for example, the sector data point 302 (e.g., FIG. 3A), the work culture data point 304 (e.g., FIG. 3B), the workstyle data point 306 (e.g., FIG. 3C), the space experience data point 308 (e.g., FIG. 3D), the health focus data point 310 (e.g., FIG. 3E), the budget data point 312 (e.g., FIG. 3F), the headcount data point 318 (e.g., FIG. 3G), the specialty spaces data point 344 (e.g., FIG. 3H), and the real estate data point 350 (e.g., FIG. 3I). However, the present disclosure is not limited to the types and numbers of data points received at block 702.

In response to receiving the inputs and requirements at block 702, workplace strategy interface 200 filters the list of functional blocks to be included in the CFL 205 from a plurality of predefined blocks at block 704. For example, the list of functional blocks may be selected based on, for example, at least the work culture data point 304. In some embodiments, the work culture data point 304 may help define the types and layouts of spaces (e.g., spatial category and function block item) that are to be included in the CFL 205.

Block attributes for each of the functional blocks may be assigned at block 706. For example, the block attributes may include at least the PAX 404 and the SEC 406. In some embodiments, the block attributes may be assigned based on the work culture/workstyle combination. In some embodiments, each of the functional blocks may have a different representation (e.g., spatial arrangement, layout, furniture, and the like) for each valid work culture/workstyle combination.

The quantity or number of each of the functional blocks may be calculated at block 708. For example, the quantity or number of each of the functional blocks may be calculated based on the work culture data point 304, workstyle data point 306, space experience data point 308, headcount data point 318, specialty spaces data point 344, and real estate data point 350. The quantity or number of each of the functional blocks may also consider collaboration space ratios, distributions between different collaboration types and sizes, and the like).

The FCL area fit for each of the functional blocks may be determined at block 710. For example, each of the functional blocks may be assigned a default area fit based on at least the headcount data point 318 (e.g., the density benchmark 340 of the headcount data point 318). In some embodiments, the FCL area fit may be automatically optimized (or upgraded) from the default area fit to maximize usage of space and to reduce or minimize unused space. In some embodiments, the FCL area fit may be automatically optimized based on a priority criteria, which may be determined from a combination of the spatial category and the work culture data point 304. In some embodiments, different combinations of the spatial category and work culture data point 304 may have different upgrade priorities. In some embodiments, the functional blocks may be manually upgraded based on user selection as needed or desired. In this case, other ones of the functional blocks may be automatically upgraded or downgraded based on spatial allowance and limitations.

The project plan or CFL 205 may then be generated by workplace strategy interface 200 at block 712, and the process may end. Accordingly, workplace design cloud platform 120 may capture user requirements in a simple questionnaire 202, analyze the project requirements based on customized knowledge base and rules, and automatically generate a detailed project plan 205 based on the user requirements and needs.

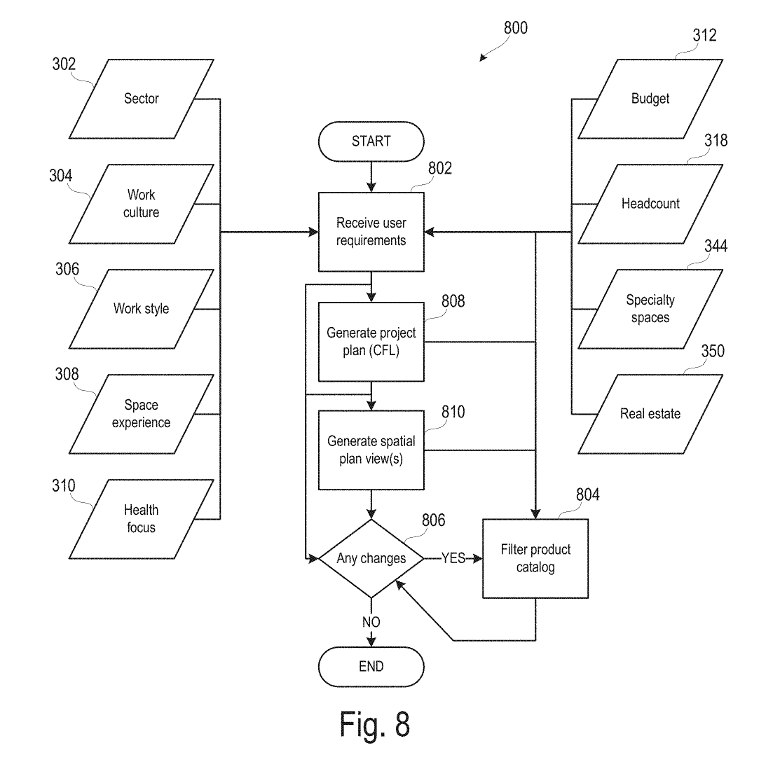

FIG. 8 is a flow diagram of a method for automatically filtering a product catalog based on user requirements and budget, according to some embodiments. Referring to FIG. 8, the process 800 starts and workplace strategy interface 200 receives user inputs and requirements at block 802. For example, workspace strategy interface 200 may receive the user inputs and requirements in response to the questionnaire 202. The user inputs and requirements may include, for example, the sector data point 302 (e.g., FIG. 3A), the work culture data point 304 (e.g., FIG. 3B), the workstyle data point 306 (e.g., FIG. 3C), the space experience data point 308 (e.g., FIG. 3D), the health focus data point 310 (e.g., FIG. 3E), the budget data point 312 (e.g., FIG. 3F), the headcount data point 318 (e.g., FIG. 3G), the specialty spaces data point 344 (e.g., FIG. 3H), and the real estate data point 350 (e.g., FIG. 3I). However, the present disclosure is not limited to the types and numbers of data points received at block 802.

In response to receiving the inputs and requirements at block 802, product and marketplace integrator 225 filters the product catalog 227 to include products and services that satisfy one or more criteria of the inputs and requirements at block 804. For example, the space experience data point 308 may be used to filter the product catalog 227 to include items and objects (e.g., products, furniture, equipment, services, and the like) that fit the selected space experience. The health focus data point 310 may be used to further filter the product catalog 227 for items and objects that fit the selected health focus. The budget data point 312 may be used to further filter the product catalog 227 to display items and objects that fall within the allowed budget. The headcount data point 318 may be used to determine a unit number of the items and objects that are needed to support the expected headcount, and may be used to further filter the items and objects of the product catalog 227 to those that fit within the allowed budget for the total unit number needed. The specialty spaces data point 344 may be used to determine the types and unit number of specialty products that may be needed. And the real estate data point 350 may be used to determine the allowable size and spatial layout of the items and objects to fit within the available space.

In some embodiments, the process 800 may determine if any changes or updates are made to the user requirements at block 806, and may accordingly further filter the product catalog at block 804 in response to detecting any changes, if necessary or desired. For example, if the user makes any edits to the responses to the questionnaire 202, product and marketplace integrator 225 may detect the edits at block 806 and may further filter the product catalog at block 804 in response to the detected changes.

In some embodiments, a project plan or CFL 205 may be generated at block 808. In response to generating the CFL 205 at block 808, or any edits to the CFL 205 at block 806, the product catalog may further be filtered at block 804. For example, the product catalog may be filtered based on the project quantity 412, FCL area fit 414, upgrades and/or downgrades to the FCL area fit 416, and/or adjustments to the internal space based on the circulation (open/closed) 422 and 424 and the building efficiency 426.

In some embodiments, spatial plan views may be generated at block 810. In response to generating the spatial plan views at block 810, or any edits to the spatial plan views at block 806, the product catalog may further be filtered at block 804. For example, depending on any adjustments to the spatial plan views or the types of items or objects that are selected or modified in the spatial plan views, the product catalog may be filtered to take into consideration the remaining budget and space for other items and objects.

If there are no more detected changes at block 806, the process 800 may end or continue at another point in the process or the beginning of the process. Accordingly, the product catalog may be dynamically filtered based on the user requirements and the budget, so that the user may select items and objects to be included in the workplace environment design that fit within the overall strategy and budget of the workplace environment design.

Further to block 804 and as previously described in connection with the product and marketplace integrator 225 via FIG. 2, the product catalog 227 may be automatically filtered based on the user's needs, budget, and requirements and/or as the design is updated or changed in accordance with process 800. For example, in some embodiments, 3^{rd} party vendors may register with product and marketplace integrator 225 to offer its products via a product catalog 227 to potential consumers and users of the workspace design cloud platform 120. In some embodiments, product and marketplace integrator 225 may automatically filter the product catalog 227 based on price, and may offer those goods fitting within a price range or criteria. In some embodiments, product and marketplace integrator 225 may automatically filter the product catalog 227 based on available budget, and may offer those goods that can meet the available budget. In some embodiments, the user may select one or more filters (e.g., based on brand, product type, price, available quantity, and/or the like), and product and marketplace integrator 224 may filter the product catalog 227 to those that satisfy the one or more user-defined filters. In some embodiments, the user may search 539 for a particular product or brand, and product and marketplace integrator 224 may return a list of goods from the product catalog 227 that match (or best match) the search 539.

Further to block 804, based on the filtered product list or catalog 227, one or more items may be purchased from a third-party marketplace 275 via the product and marketplace integrator 225, including selection of delivery times or schedules. A graphical representation of the purchased items may be provided by (or copied or selected from) the product catalog 227, platform or third-party marketplace to be placed or used in the design workspace. A user via the user interface of the platform may arrange and place such items in the design workspace. The platform may also in real-time update the BOM with the associated costs of the purchased items responsive to purchasing the items.

While the disclosure has been particularly shown and described with reference to specific embodiments, it should be understood by those skilled in the art that various changes in form and detail may be made therein without departing from the spirit and scope of the disclosure described in this disclosure.

What is claimed is:

1. A method of spatially designing a workplace environment via a cloud platform, the method comprising:
receiving, by a user interface of a workspace design cloud platform executing one or more processors, user input providing a plurality of design requirements for a workplace environment design comprising a graphical representation of a workplace environment;
identifying, by one or more rules of the workspace design cloud platform in communication with a knowledge base, one or more functional blocks from among a plurality of predefined functional blocks based at least on the plurality of design requirements, the predefined functional blocks graphically representing a plurality of work space designs, and each of the one or more functional blocks graphically representing one or more work spaces to be included in the workplace environment design;
generating, by the workplace design cloud platform, a customized functional list for the workplace environment design, the customized functional list including a list of each of the functional blocks and one or more attributes associated with each of the functional blocks; and
generating, by the workplace design cloud platform, one or more spatial plan views of the workplace environment design based at least on the customized functional list, each of the one or more spatial plan views including a visual representation of each of the one or more work spaces of the functional blocks spatially arranged within the workplace environment design.

2. The method of claim 1, wherein each of the predefined functional blocks include one or more parameters that define a space for a corresponding work space design.

3. The method of claim 2, wherein the one or more parameters include a category parameter that characterizes a spatial type of the space.

4. The method of claim 3, wherein the one or more parameters further include a type parameter that defines a function or size of the space.

5. The method of claim 4, wherein the one or more parameters further include a PAX parameter that defines a number of persons or seats that can occupy the space.

6. The method of claim 2, wherein the identifying of the one or more functional blocks includes:
identifying, by the workspace design cloud platform, a first data point of the user input, the first data point indicating types of spaces, spatial layout, and spatial placement for the one or more work spaces associated with the workplace environment design; and
filtering, by the workspace design cloud platform, the predefined functional blocks based on the first data point to isolate the predefined blocks that have the work space designs corresponding to the one or more work spaces associated with the workplace environment design.

7. The method of claim 6, wherein the first data point is a work culture data point corresponding to an aspired work culture defining a spatial plan for the workplace environment design.

8. The method of claim 6, wherein the identifying of the one or more functional blocks further includes:
assigning, by the workspace design cloud platform, block attributes for each of the one or more workspaces associated with the workplace environment design; and
selecting, by the workspace design cloud platform, one or more of the filtered predefined blocks having the one or more parameters that correspond to the block attributes assigned for the one or more workspaces associated with the workplace environment design.

9. The method of claim 8, further comprising:
assigning, by the workspace design cloud platform, an area fit for each of the selected predefined blocks; and
optimizing, by the workspace design cloud platform, each of the selected predefined blocks based at least on the area fit and available space.

10. The method of claim 9, wherein the optimizing of the selected predefined blocks includes:
determining, by the workspace design cloud platform, an upgrade priority based at least on the first data point for each of the one or more workspaces associated with the workplace environment design; and
upgrading, by the workspace design cloud platform, one or more of the functional blocks based on the upgrade priority to reduce residual space.

11. A workplace design cloud platform for spatially designing a workplace environment, the platform comprising:
one or more processors; and
non-transient computer-readable storage media communicably coupled to the one or more processors and having instructions stored thereon that, when executed by the one or more processors, cause the one or more processors to:
receive, via a user interface generated by the one or more processors, user input providing a plurality of design requirements for a workplace environment design comprising a graphical representation of a workplace environment;
identify, based on one or more rules in communication with a knowledge base, one or more functional blocks from among a plurality of predefined functional blocks based at least on the plurality of design requirements, the predefined functional blocks graphically representing a plurality of work space designs, and each of the one or more functional blocks graphically representing one or more work spaces to be included in the workplace environment design;
generate a customized functional list for the workplace environment design, the customized functional list including a list of each of the functional blocks and one or more attributes associated with each of the functional blocks; and
generate one or more spatial plan views of the workplace environment design based at least on the customized functional list, each of the one or more spatial plan views including a visual representation of each of the one or more work spaces of the functional blocks spatially arranged within the workplace environment design.

12. The platform of claim 11, wherein each of the predefined functional blocks include one or more parameters that define a space for a corresponding work space design.

13. The platform of claim 12, wherein the one or more parameters include a category parameter that characterizes a spatial type of the space.

14. The platform of claim 13, wherein the one or more parameters further include a type parameter that defines a function or size of the space.

15. The platform of claim 14, wherein the one or more parameters further include a PAX parameter that defines a number of persons or seats that can occupy the space.

16. The platform of claim 12, wherein to identify the one or more functional blocks, the instructions further cause the one or more processors to:
identify a first data point of the user input, the first data point indicating types of spaces, spatial layout, and spatial placement for the one or more work spaces associated with the workplace environment design; and
filter the predefined functional blocks based on the first data point to isolate the predefined blocks that have the work space designs corresponding to the one or more work spaces associated with the workplace environment design.

17. The platform of claim 16, wherein the first data point is a work culture data point corresponding to an aspired work culture defining a spatial plan for the workplace environment design.

18. The platform of claim 16, wherein to identify the one or more functional blocks, the instructions further cause the one or more processors to:
assign block attributes for each of the one or more workspaces associated with the workplace environment design; and
select one or more of the filtered predefined blocks having the one or more parameters that correspond to the block attributes assigned for the one or more workspaces associated with the workplace environment design.

19. The platform of claim 18, wherein the instructions further cause the one or more processors to:
assign an area fit for each of the selected predefined blocks; and
optimize each of the selected predefined blocks based at least on the area fit and available space.

20. The platform of claim 19, wherein to optimize the selected predefined blocks, the instructions further cause the one or more processors to:
determine an upgrade priority based at least on the first data point for each of the one or more workspaces associated with the workplace environment design; and
upgrade one or more of the functional blocks based on the upgrade priority to reduce residual space.
